(19) United States
(12) Patent Application Publication
(10) Pub. No.: US 2025/0258283 A1
(43) Pub. Date: Aug. 14, 2025

(54) PHOTODETECTION DEVICE, DISTANCE MEASURING DEVICE, AND ELECTRONIC DEVICE

(71) Applicant: SONY SEMICONDUCTOR SOLUTIONS CORPORATION, KANAGAWA (JP)

(72) Inventor: TAKAFUMI TAKATSUKA, KANAGAWA (JP)

(21) Appl. No.: 18/851,149

(22) PCT Filed: Feb. 24, 2023
(86) PCT No.: PCT/JP2023/006787

§ 371 Date: Sep. 26, 2024

(30) Foreign Application Priority Data
Apr. 7, 2022 (JP) 2022-064104

(51) Int. Cl. G01S 7/4865; G01S 7/481; G01S 17/10

(52) U.S. Cl. CPC G01S 7/4865; G01S 7/4816; G01S 17/10

(57) ABSTRACT

To provide a photodetection device capable of improving sensitivity characteristics under an environment of high illuminance.

A photodetection device according to the present disclosure includes: a plurality of pixels that counts the number of photons included in incident light; a memory that stores a correction value used to correct a count value by each of the plurality of pixels; and a correction circuit that corrects the count value by using the correction value. In the photodetection device, the plurality of pixels includes: an optical response unit that reacts to the photons; a pulse detection unit that includes an input transistor to which a result of reaction of the optical response unit is input and detects a pulse indicating the result of reaction; a counter that measures the count value on the basis of the pulse; a dynamic separation switch unit that dynamically separates electrical connection between the optical response unit and the pulse detection unit; and an input fixing unit that temporarily fixes an input voltage of the pulse detection unit to a potential at which the input transistor is turned on.

### TECHNICAL FIELD

The present disclosure relates to a photodetection device, a distance measuring device, and an electronic device.

### BACKGROUND ART

In a plurality of fields such as in-vehicle and mobile, application has been advanced of a photodetection device that measures a distance to an object on the basis of a time of flight (ToF) until irradiation light from a light source is reflected by the object and returns to a detector. An avalanche photodiode (APD) is arranged as a light receiving element in each of a plurality of pixels in the photodetection device. In the APD in the Geiger mode, a voltage greater than or equal to a breakdown voltage is applied across terminals, and an avalanche phenomenon occurs due to incidence of a single photon. The APD that multiplies a single photon by the avalanche phenomenon is called a single photon avalanche diode (SPAD).

In the SPAD, it is possible to stop the avalanche phenomenon by lowering the voltage across the terminals to the breakdown voltage. Thereafter, when the voltage across the terminals of the SPAD is recharged to a bias voltage greater than or equal to the breakdown voltage, it becomes possible to detect a photon. As described above, in the photodetection device including the SPAD, a time from when the avalanche phenomenon occurs to when recharging ends is a dead time in which photons cannot be counted.

### CITATION LIST

### Patent Document

Patent Document 1: WO 2021/090691 A

### SUMMARY OF THE INVENTION

### Problems to be Solved by the Invention

In a photodetection device including a plurality of pixels, the dead time described above may vary among pixels due to manufacturing variations or the like. In this case, in an environment of high illuminance, variation occurs in an amount of count loss indicating a ratio of the number of photons not counted by the photodetection device to the number of photons included in incident light. This variation in the amount of count loss can be a factor of deterioration of sensitivity characteristics such as photo response non-uniformity (PRNU).

Thus, the present disclosure provides a photodetection device, a distance measuring device, and an electronic device capable of improving sensitivity characteristics under an environment of high illuminance.

### Solutions to Problems

A photodetection device according to one aspect of the present disclosure includes: a plurality of pixels that counts the number of photons included in incident light; a memory that stores a correction value used to correct a count value by each of the plurality of pixels; and a correction circuit that corrects the count value by using the correction value. In the photodetection device, the plurality of pixels includes: an optical response unit that reacts to the photons; a pulse detection unit that includes an input transistor to which a result of reaction of the optical response unit is input and detects a pulse indicating the result of reaction; a counter that measures the count value on the basis of the pulse; a dynamic separation switch unit that dynamically separates electrical connection between the optical response unit and the pulse detection unit; and an input fixing unit that temporarily fixes an input voltage of the pulse detection unit to a potential at which the input transistor is turned on.

The potential at which the input transistor is turned on may be a ground potential.

The photodetection device may further include a processing circuit that calculates a dead time generated at a time of counting the number of photons on the basis of the counter value.

The correction value may be a dead time calculated by the processing circuit when the input voltage is fixed to the ground potential.

The correction circuit may correct a counter value measured by the counter at a time of a state where the pulse detection unit is connected to the optical response unit, by the input fixing unit.

The memory may be a frame memory that stores the correction values of all of the plurality of pixels.

The photodetection device may further include an addition circuit that adds together the pulses of a plurality of the pulse detection units respectively arranged in the plurality of pixels, in which
the counter may calculate the count value on the basis of an addition value calculated by the addition circuit.

The photodetection device may further includes an addition circuit that adds together output signals of a plurality of the optical response units respectively arranged in the plurality of pixels, in which
the pulse detection unit may detect the pulse on the basis of an addition value calculated by the addition circuit.

The photodetection device may further include:
a drive circuit that outputs a drive signal for driving the plurality of pixels; and
a timing adjustment circuit that is arranged between the plurality of pixels and the drive circuit and adjusts a timing of transmitting the drive signal to the plurality of pixels.

The plurality of pixels may include a plurality of first pixels and at least one or more second pixels, and
the photodetection device may further include an averaging calculation circuit that calculates an average value of the dead time, in which
the correction circuit may include: a comparison circuit that calculates an environmental correction coefficient on the basis of a result of comparison between the average value calculated when the input voltage is fixed to the ground potential and the average value calculated when the pulse detection unit and the optical response unit are connected together; and a main calculation circuit that corrects the count value by each of the first pixels by using the environmental correction coefficient.

The second pixels each may be a pixel in which the input voltage is always fixed to the ground potential or a light-shielded pixel for which the incident light is shielded.

The comparison circuit may calculate the environmental correction coefficient on the basis of a result of comparison between the average value for the first pixels calculated when the input voltage is fixed to the ground potential and the average value for the second pixels calculated when the pulse detection unit and the optical response unit are connected together.

The plurality of pixels may include a plurality of first pixels and at least one or more second pixels that are smaller in number than the plurality of first pixels and for which the incident light is shielded, and
the photodetection device may further include an averaging calculation circuit that calculates an average value of the dead time, in which
the correction circuit may include: a main calculation circuit that corrects the count value by each of the first pixels; and a subtraction circuit that subtracts the average value for the second pixels from a calculated value by the main calculation circuit.

The correction circuit may further include a comparison circuit that calculates an environmental correction coefficient on the basis of a result of comparison between the average value for the first pixels calculated when the input voltage is fixed to the ground potential and the average value for the second pixels calculated when the pulse detection unit and the optical response unit are connected together, and
the main calculation circuit may correct the count value by each of the first pixels by using the environmental correction coefficient.

A pixel array unit may be further included in which the plurality of first pixels and a plurality of the second pixels are arranged in a matrix,
the plurality of first pixels may be arranged in a central region of the pixel array unit, and
the plurality of second pixels may be arranged side by side in a row direction and a column direction to surround an arrangement region for the plurality of first pixels.

The second pixels may be arranged on a substrate different from that for the first pixels are arranged.

The photodetection device may further include a pixel array unit in which the plurality of first pixels and the second pixels are arranged in a matrix, in which
the second pixels may be arranged in a distributed manner in the pixel array unit.

The pulse detection unit may include a delayer that delays output of the pulse to the counter, and
the photodetection device may further include an adjustment circuit that adjusts a delay time of the delayer on the basis of the dead time.

A distance measuring device according to one aspect of the present disclosure includes a plurality of photodetection devices. In the distance measuring device, each of the plurality of photodetection devices includes:
a plurality of pixels that counts the number of photons included in incident light;
a memory that stores a correction value used to correct a count value by each of the plurality of pixels; and
a correction circuit that corrects the count value by using the correction value.

Furthermore, the plurality of pixels includes:
an optical response unit that reacts to the photons;
a pulse detection unit that includes an input transistor to which a result of reaction of the optical response unit is input and detects a pulse indicating the result of reaction;
a counter that measures the count value on the basis of the pulse;
a dynamic separation switch unit that dynamically separates electrical connection between the optical response unit and the pulse detection unit; and
an input fixing unit that temporarily fixes an input voltage of the pulse detection unit to a potential at which the input transistor is turned on.

An electronic device according to one aspect of the present disclosure includes a photodetection device. In the electronic device, the photodetection device includes:
a plurality of pixels that counts the number of photons included in incident light;
a memory that stores a correction value used to correct a count value by each of the plurality of pixels; and
a correction circuit that corrects the count value by using the correction value.

Furthermore, the plurality of pixels includes:
an optical response unit that reacts to the photons;
a pulse detection unit that includes an input transistor to which a result of reaction of the optical response unit is input and detects a pulse indicating the result of reaction;
a counter that measures the count value on the basis of the pulse;
a dynamic separation switch unit that dynamically separates electrical connection between the optical response unit and the pulse detection unit; and
an input fixing unit that temporarily fixes an input voltage of the pulse detection unit to a potential at which the input transistor is turned on.

### BRIEF DESCRIPTION OF DRAWINGS

FIG. 1 is a block diagram illustrating a schematic configuration of a photodetection device according to a first embodiment.

FIG. 2 is a diagram illustrating an example of a circuit configuration of a pixel according to the first embodiment.

FIG. 3A is a diagram illustrating an example of a circuit configuration of a delayer.

FIG. 3B is a diagram illustrating an example of the circuit configuration of the delayer.

FIG. 3C is a diagram illustrating an example of the circuit configuration of the delayer.

FIG. 3D is a diagram illustrating an example of the circuit configuration of the delayer.

FIG. 4 is a sequence diagram for explaining a correction sequence according to the first embodiment.

FIG. 5 is a timing chart illustrating an example of an imaging operation of the photodetection device.

FIG. 6 is a perspective view illustrating an implementation example of the photodetection device according to the first embodiment.

FIG. 7 is a block diagram illustrating a schematic configuration of a pixel array unit according to a first modification.

FIG. 8 is a block diagram illustrating a configuration of a photodetection device according to a second modification.

FIG. 9 is a block diagram illustrating a configuration of a photodetection device according to a third modification.

FIG. 10 is a block diagram illustrating a schematic configuration of a photodetection device according to a second embodiment.

FIG. 11 is a diagram illustrating an example of a circuit configuration of a second pixel.

FIG. 12 is a sequence diagram for explaining a correction sequence according to the second embodiment.

FIG. 13 is a block diagram illustrating a schematic configuration of a photodetection device according to a fourth modification.

FIG. 14 is a sequence diagram for explaining a correction sequence according to the fourth modification.

FIG. 15 is a block diagram illustrating a schematic configuration of a photodetection device according to a fifth modification.

FIG. 16 is a sequence diagram for explaining a correction sequence according to the fifth modification.

FIG. 17 is a block diagram illustrating a schematic configuration of a photodetection device according to a sixth modification.

FIG. 18 is a sequence diagram for explaining a correction sequence according to the sixth modification.

FIG. 19 is a block diagram illustrating a schematic configuration of a photodetection device according to a seventh modification.

FIG. 20 is a block diagram illustrating a schematic configuration of a photodetection device according to an eighth modification.

FIG. 21 is a block diagram illustrating a schematic configuration of a photodetection device according to a third embodiment.

FIG. 22 is a sequence diagram of delay time optimization processing.

FIG. 23 is a diagram illustrating an example of a circuit configuration of a pixel according to a fourth embodiment.

FIG. 24 is a diagram schematically illustrating an example of distance measurement using a photodetection device.

FIG. 25 is a block diagram illustrating a schematic configuration of a distance measuring device according to a fifth embodiment.

FIG. 26 is a block diagram illustrating a schematic configuration of an electronic device according to a sixth embodiment.

FIG. 27 is a block diagram illustrating an example of a schematic configuration of a vehicle control system.

FIG. 28 is an explanatory diagram illustrating an example of installation positions of an outside-vehicle information detecting section and an imaging section.

### MODE FOR CARRYING OUT THE INVENTION

Hereinafter, a preferred embodiment of the present disclosure will be described in detail with reference to the accompanying drawings. Note that, in the present specification and the drawings, components having substantially the same functional configuration are denoted by the same reference signs, and redundant description will be omitted.

### First Embodiment

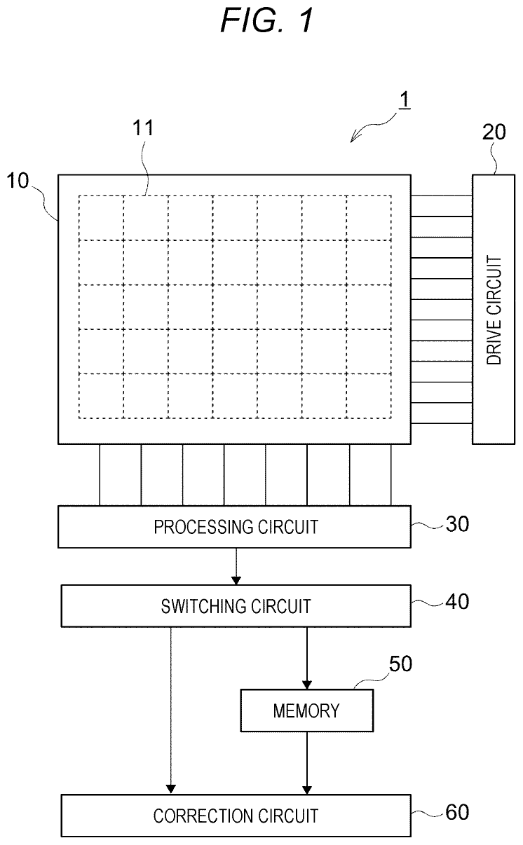

FIG. 1 is a block diagram illustrating a schematic configuration of a photodetection device according to a first embodiment. A photodetection device 1 illustrated in FIG. 1 includes a pixel array unit 10, a drive circuit 20, a processing circuit 30, a switching circuit 40, a memory 50, and a correction circuit 60.

In the pixel array unit 10, a plurality of pixels 11 is arranged in a two-dimensional matrix. Each pixel 11 counts the number of photons included in incident light. The drive circuit 20 outputs a drive signal for driving the pixel array unit 10 to each pixel 11. The processing circuit 30 calculates a dead time td indicating a delay time generated at the time of photon detection in each pixel 11 on the basis of a count value by each pixel 11. The switching circuit 40 switches an output destination of a calculated value by the processing circuit 30 to the memory 50 or the correction circuit 60. The memory 50 stores a correction value used to correct the count value by each pixel 11. Note that, in the present embodiment, the memory 50 is a frame memory that stores correction values of all the pixels 11. The correction circuit 60 corrects the count value by each pixel 11 on the basis of the correction value.

In the photodetection device 1 according to the present embodiment, all of the pixel array unit 10 to the correction circuit 60 are arranged on one chip (substrate), but arrangement of the circuits is not limited thereto. For example, the pixel array unit 10, the drive circuit 20, the processing circuit 30, and the switching circuit 40 may be arranged on one chip, and the memory 50 and the correction circuit 60 may be arranged on another chip bonded to the one chip. In this case, the memory 50 can be manufactured by a process different from that for the pixel array unit 10. Furthermore, for example, when the memory 50 is configured by a nonvolatile memory, the dead time td can be written and saved at a manufacturing stage, so that it is not necessary to acquire the dead time td at an imaging stage. As a result, time required for imaging processing can be shortened.

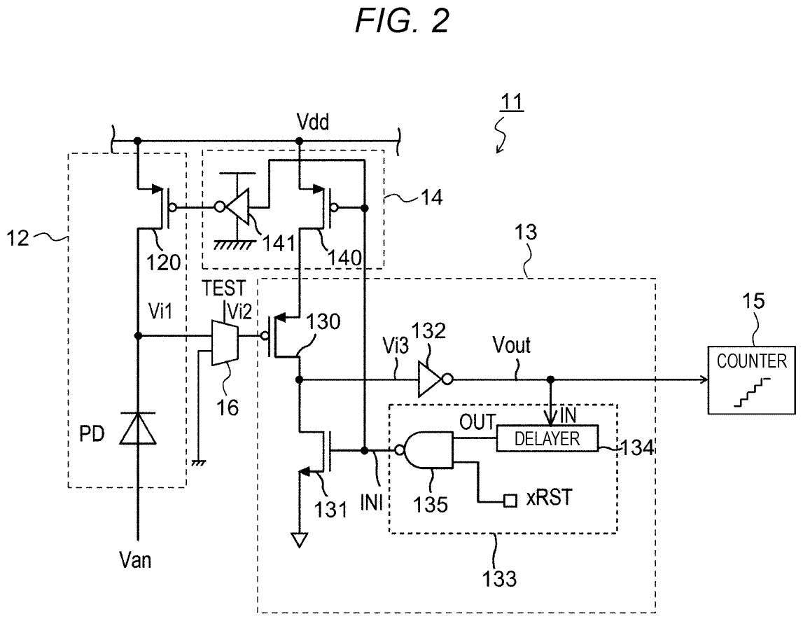

FIG. 2 is a diagram illustrating an example of a circuit configuration of the pixel 11. The pixel 11 illustrated in FIG. 2 includes an optical response unit 12, a pulse detection unit 13, a dynamic separation switch unit 14, a counter 15, and an input fixing unit 16.

The optical response unit 12 includes a photodiode PD that reacts to photons of the incident light, and a transistor 120 connected in series to the photodiode PD. The photodiode PD is, for example, an avalanche photodiode (APD) represented by a single photon avalanche diode (SPAD). A voltage Van is applied to the anode of the photodiode PD. A value of the voltage Van is set so that a reverse voltage greater than or equal to a breakdown voltage is applied across the cathode and the anode (across terminals) of the photodiode PD. The cathode of the photodiode PD is connected to the drain of the transistor 120. The transistor 120 is a P-channel MOS transistor. The source of the transistor 120 is connected to a power supply potential Vdd. The gate of the transistor 120 is connected to an output terminal of an inverter 141 provided in the dynamic separation switch unit 14.

The pulse detection unit 13 is a circuit that outputs a pulse according to the number of photons reacted by the photodiode PD, and includes an input transistor 130, a transistor 131, an inverter 132, and a pulse generator 133. The pulse generator 133 is provided with a delayer 134 and a NAND circuit 135.

The input transistor 130 is a P-channel MOS transistor. The source of the input transistor 130 is connected to the drain of a transistor 140 provided in the dynamic separation switch unit 14. The drain of the input transistor 130 is connected to an input terminal of the inverter 132 via a signal line Vi3 and is also connected to the drain of the transistor 131. The gate of the input transistor 130 is connected to an output terminal of the input fixing unit 16. The transistor 131 is an N-channel MOS transistor. The source of the transistor 131 is connected to a ground potential. The gate of the transistor 131 is connected to an output terminal of the NAND circuit 135 provided in the pulse generator 133 via a signal line INI, and is also connected to the gate of the transistor 140 provided in the dynamic separation switch unit 14 and an input terminal of the inverter 141.

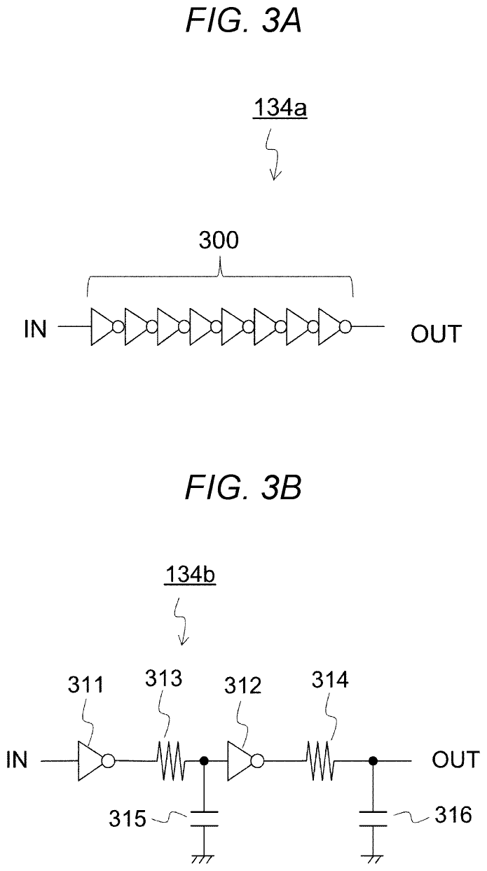

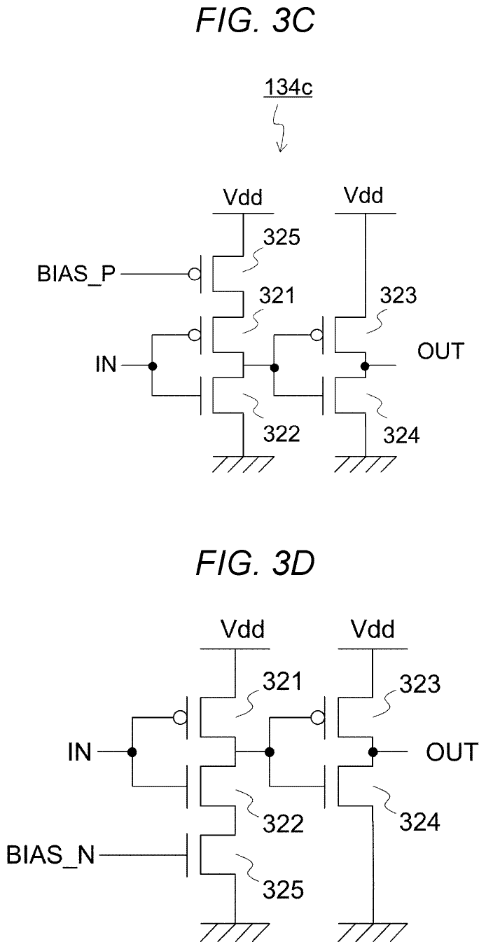

An output terminal of the inverter 132 is connected to the counter 15 via a signal line Vout. The delayer 134 is connected between the signal line Vout and one input terminal of the NAND circuit 135. The other input terminal of the NAND circuit 135 is connected to a terminal xRST. Here, a circuit configuration of the delayer will be described with reference to FIGS. 3A to 3D.

FIGS. 3A to 3D are diagrams illustrating an example of the circuit configuration of the delayer. A delayer 134a illustrated in FIG. 3A includes an inverter chain 300. In the inverter chain 300, eight inverters are connected together in series between an input terminal IN and an output terminal OUT. However, the number of inverters included in the inverter chain 300 is not limited to eight. Furthermore, the number of inverters may be an even number or an odd number according to a delay time of the delayer 134a.

In a delayer 134b illustrated in FIG. 3B, two inverters 311 and 312 and two resistance elements 313 and 314 are alternately connected together in series between the input terminal IN and the output terminal OUT. Furthermore, one end of a capacitance element 315 is connected between the resistance element 313 and the inverter 312. The other end of the capacitance element 315 is grounded. Furthermore, one end of a capacitance element 316 is connected between the resistance element 314 and the output terminal OUT. The other end of the capacitance element 316 is grounded. Resistance values of the resistance elements 313 and 314 and capacitance values of the capacitance elements 315 and 316 are set according to a delay time of the delayer 134b.

A delayer 134c illustrated in FIG. 3C includes MOS transistors 321 to 325. The MOS transistor 321, the MOS transistor 323, and the MOS transistor 325 are P-channel types, and the MOS transistor 322 and the MOS transistor 324 are N-channel types.

In the MOS transistor 321 and the MOS transistor 322, the drains are connected to each other, and the gates are commonly connected to the input terminal IN. Furthermore, the source of the MOS transistor 321 is connected to the drain of the MOS transistor 325. The source of the MOS transistor 322 is grounded.

In the MOS transistor 323 and the MOS transistor 324, the drains are commonly connected to the output terminal OUT, and the gates are commonly connected to the drains of the MOS transistor 321 and the MOS transistor 322. Furthermore, the source of the MOS transistor 323 is fixed to the power supply potential Vdd. The source of the MOS transistor 3224 is grounded.

The source of the MOS transistor 325 is fixed to the power supply potential Vdd. A bias signal BIAS_P is input from the drive circuit 20 to the gate of the MOS transistor 325. A delay time of the delayer 134c can be set according to a voltage of the bias signal BIAS_P.

A delayer 134d illustrated in FIG. 3D also includes MOS transistors 321 to 325 similarly to the delayer 134c described above. However, in the delayer 134d, the MOS transistor 325 is an N-channel type.

The drain of the MOS transistor 325 is connected to the source of the MOS transistor 322, and the source is grounded. Furthermore, a bias signal BIAS_N is input from the drive circuit 20 to the gate. A delay time of the delayer 134d can be set according to a voltage of the bias signal BIAS_N.

Returning to FIG. 1, the dynamic separation switch unit 14 is a circuit that dynamically separates electrical connection between the optical response unit 12 and the pulse detection unit 13, and includes the transistor 140 and the inverter 141. The transistor 140 is. A P-channel MOS transistor. The source of the transistor 140 is connected to the power supply potential Vdd. The input terminal of the inverter 141 is connected to the output terminal of the NAND circuit 135 together with the gate of the transistor 140.

The counter 15 counts the number of pulses input through the signal line Vout, that is, the number of times the photodiode PD has reacted to photons.

The input fixing unit 16 is connected between the gate of the input transistor 130 and a signal line Vi1. One input terminal of the input fixing unit 16 is connected to the optical response unit 12 via the signal line Vi1. The other input terminal of the input fixing unit 16 is fixed to the ground potential. An output terminal of the input fixing unit 16 is connected to the gate of the input transistor 130. The input fixing unit 16 fixes a gate potential of the input transistor 130, in other words, an input voltage Vi2 of the pulse detection unit 13, on the basis of a test signal TEST input from the drive circuit 20. In a case where the test signal TEST is at a high level, the input fixing unit 16 connects the gate of the input transistor 130 to the cathode of the photodiode PD via the signal line Vi1. On the other hand, in a case where the test signal TEST is at a low level, the input fixing unit 16 fixes the gate of the input transistor 130 to the ground potential.

In the pixel 11 configured as described above, when the photodiode PD reacts to the photons included in the incident light, and a voltage of the signal line Vi1 is the low level, and a voltage of the signal line Vi3 is the high level, and a voltage of the signal line Vout is the low level (when a pulse of the low level is output to the signal line Vout), the NAND circuit 135 outputs a voltage of the high level to the signal line INI. In this case, the inverter 141 outputs a voltage of the low level, so that the voltage of the low level is applied to the gate of the transistor 120. As a result, the transistor 120 is turned on. Thus, potentials of the signal line Vi1 and the cathode of the photodiode PD are pulled up to the high level by the power supply potential Vdd. As a result, a voltage across the terminals of the photodiode PD is lowered to the breakdown voltage, and an avalanche phenomenon is stopped (quenching of the photodiode PD is performed).

Furthermore, when the voltage of the signal line INI is at the high level, the voltage of the high level is applied to the gates of the transistor 140 and the transistor 131. Thus, the transistor 140 is turned off, and the transistor 131 is turned on. For this reason, the voltage of the signal line Vi3 is initialized by the ground potential and is the low level. When the voltage of the signal line Vi3 is the low level, the inverter 132 outputs a voltage of the high level to the signal line Vout. As a result, a voltage of the one input terminal of the NAND circuit 135 is the high level with a delay by the delayer 134. Moreover, when a voltage of the high level is applied to the terminal xRST, the NAND circuit 135 outputs a voltage of the low level to the signal line INI. At this time, a voltage of the high level inverted by the inverter 141 is applied to the gate of the transistor 120. Since the transistor 120 is turned off, the signal line Vi1 is electrically disconnected from the power supply potential Vdd. Since the voltage across the terminals of the photodiode PD is greater than or equal to the breakdown voltage, the pixel 11 can detect photons again.

When illuminance of light incident on the photodetection device 1 according to the present embodiment increases, the number of photons received by the photodiode PD increases, and thus the number of pulses output from the pulse detection unit 13 also increases. At this time, when the photodiode PD receives light of ultra-high illuminance such as sunlight, for example, a plurality of pulses is connected together, and there is a concern that the count value of photons measured by the counter 15 may be significantly lower than the actual number of photons of the incident light.

Thus, the photodetection device 1 according to the present embodiment is provided with the dynamic separation switch unit 14. The dynamic separation switch unit 14 can dynamically separate the optical response unit 12 and the pulse detection unit 13 from each other. That is, the dynamic separation switch unit 14 temporarily brings the signal line Vi1 and the signal line Vi3 into an electrically insulated state from each other. For that reason, it is possible to avoid continuous input of signals from the optical response unit 12 to the pulse detection unit 13. As a result, sensitivity characteristics at high illuminance can be improved.

On the other hand, in the photodetection device 1, variation can occur in the dead time td generated at the time of photon detection among the pixels 11 in the pixel array unit 10. The variation in the dead time td causes variation in an amount of count loss of photons at high illuminance. As a result, it is difficult to accurately count the photons of the incident light.

Thus, in the present embodiment, the input fixing unit 16 corrects the number of photons of the incident light for each pixel 11. Hereinafter, a correction sequence for the number of photons of the incident light will be described.

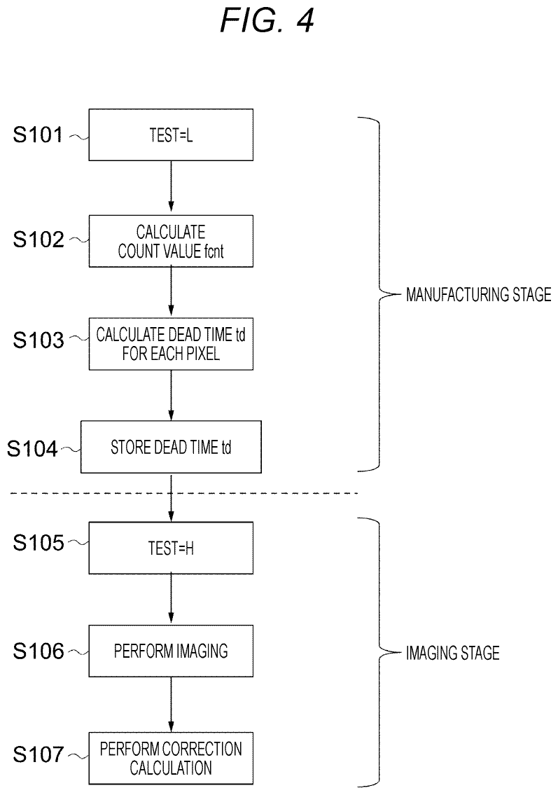

FIG. 4 is a sequence diagram for explaining the correction sequence according to the first embodiment.

In the sequence illustrated in FIG. 4, first, the drive circuit 20 inputs the test signal TEST of the low level to the input fixing units 16 of all the pixels 11 (step S101). As a result, the gate potential of the input transistor 130 of the pulse detection unit 13 is fixed to the ground potential. As a result, the input voltage Vi2 (see FIG. 2) of the pulse detection units 13 of all the pixels 11 is fixed to the ground potential. Subsequently, the counter 15 of each pixel 11 counts the number of pulses output from the signal line Vout under a condition that the input voltage Vi2 is fixed to the ground potential, to calculate a count value fcnt of the photons (step S102).

Next, the processing circuit 30 calculates the dead time td for each pixel 11 (step S103). Here, a dead time td_i of a certain pixel i that is one pixel 11 in the pixel array unit 10 will be described. A count value fcnt_i of photons per second in the pixel i can be calculated by Expression (1) below.

$$[ Ex . 1 ]$$

$${f}_{cnt\_i} = \frac{1}{\frac{1}{{f}_{p\_i}} + {t}_{d\_i}} \qquad ( 1 )$$

In Expression (1), fp_i represents a frequency of the incident light, in other words, the number of photons of the incident light per second. Fixing the input voltage Vi2 to the ground potential in step S101 corresponds to a condition of ultra-high illuminance in which the count value fp_i of the photons of the incident light is infinite. In a case where the count value fp_i of the photons is infinite, Expression (1) can be transformed into Expression (2) below.

$$[ Ex . 2 ]$$

$${f}_{cnt\_i} = \frac{1}{{t}_{d\_i}} \qquad ( 2 )$$

The count value fcnt_i when the count value fp_i of the photons is infinite is a maximum count value that can be measured by the counter 15. In step S102, the count value fcnt_i is measured by the counter 15. Thus, in step S103, the processing circuit 30 calculates the dead time td for each pixel 11 by using Expression (2) described above.

Next, the switching circuit 40 connects the processing circuit 30 and the memory 50 to each other. As a result, data values indicating the dead times td of all the pixels 11 calculated by the processing circuit 30 are stored in the memory 50 (step S104).

Operations in steps S101 to S104 described above are performed at the manufacturing stage of the photodetection device 1, for example, at the time of a manufacturing test.

Subsequently, an operation at the imaging stage of the commercialized photodetection device 1 will be described.

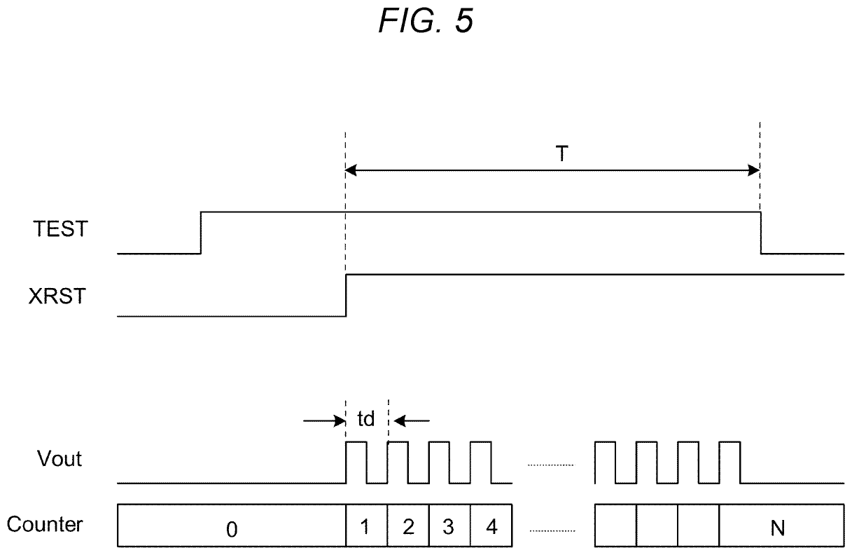

FIG. 5 is a timing chart illustrating an example of an imaging operation of the photodetection device 1. At the imaging stage, first, the drive circuit 20 inputs the test signal TEST of the high level to the input fixing units 16 of all the pixels 11 (step S105). As a result, the input fixing unit 16 connects the gate of the input transistor 130 of the pulse detection unit 13 to the cathode of the photodiode PD.

Next, each pixel 11 performs imaging processing of counting the number of photons included in the light received by the photodiode PD (step S106). Here, an operation in step S106 will be described.

In each pixel 11, when a potential of the terminal xRST connected to the other input terminal of the NAND circuit 135 is switched from the low level to the high level, the pulse detection unit 13 outputs pulses to the counter 15 through the signal line Vout. The counter 15 measures the count value fcnt on the basis of the pulses. At this time, the counter 15 calculates the count value fcnt in an exposure time T until the test signal TEST is switched from the high level to the low level after the potential of the terminal xRST is switched from the low level to the high level.

Subsequently, the switching circuit 40 switches the connection destination of the processing circuit 30 from the memory 50 to the correction circuit 60. As a result, the count value fcnt measured in the exposure time T is input to the correction circuit 60 via the processing circuit 30 and the switching circuit 40. This completes the operation in step S106.

The correction circuit 60 corrects the count value fcnt by using the count value fcnt calculated in the exposure time T and the dead time td stored in the memory 50 (step S107). Here, step S107 will be described in detail. When Expression (1) described above is transformed, the count value fp_i of the photons of the incident light per second can be expressed by Expression (3) below.

$$[ Ex . 3 ]$$

$${f}_{p\_i} = \frac{1}{\frac{1}{{f}_{cnt\_i}} + {t}_{d\_i}} \qquad ( 3 )$$

For that reason, the number of photons of the incident light in the exposure time T seconds can be expressed by Expression (4) below.

$$[ Ex . 4 ]$$

$${f}_{p\_i} \cdot T = \frac{T}{\frac{1}{{f}_{cnt\_i} \cdot T} - \frac{{t}_{d\_i}}{T}} \qquad ( 4 )$$

In Expression (4), fcnt_i·T is a count value measured by the counter 15 at the time of imaging with the exposure time T. Furthermore, td_i is a correction value stored in the memory 50. The correction circuit 60 corrects the counter value fcnt_i·T by using Expression (4). As a result, it is possible to accurately calculate the count value fp_i of the photons of the incident light in the exposure time T.

Following the correction sequence described above, an implementation example of the photodetection device 1 according to the present embodiment will be described.

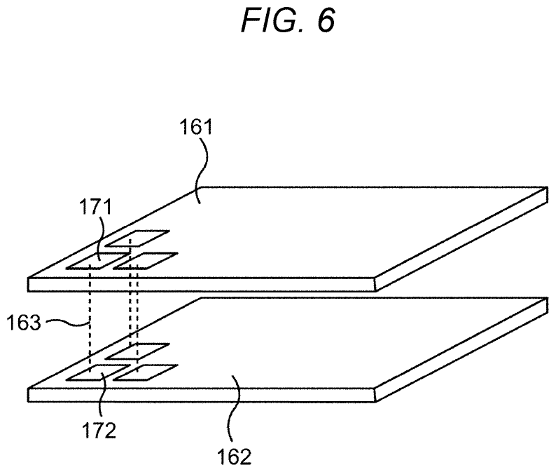

FIG. 6 is a perspective view illustrating the implementation example of the photodetection device 1 according to the present embodiment. FIG. 6 illustrates a substrate 161 and a substrate 162. The substrate 161 and the substrate 162 are, for example, silicon substrates. However, materials of the substrate 161 and the substrate 162 are not limited to silicon. The photodiodes PD of the respective pixels 11 are formed in a plurality of light receiving regions 171 of the substrate 161. Since at least a part of a surface of the photodiode PD is open, the photodiode PD can react to incident photons.

Circuit regions 172 corresponding to the respective light receiving regions 171 are formed on the substrate 162. In each circuit region 172, for example, circuit elements (pulse detection unit 13, dynamic separation switch unit 14, counter 15, input fixing unit 16) and the like are formed other than the photodiode PD in the pixel 11 illustrated in FIG. 2. The light receiving region 171 of the substrate 161 and the circuit region 172 of the substrate 162 are electrically joined to each other by copper wire connection, so-called copper-copper connection (Cu—Cu connection) 163. By adopting the Cu—Cu connection 163, it is possible to achieve downsizing of the photodetection device and reduction in production cost.

When only the photodiode PD is formed in the light receiving region 171, an area of the photodiode PD can be maximized. Furthermore, in the light receiving region 171, other elements may be formed in addition to the photodiode PD. For example, the transistor 120 connected in series to the photodiode PD may be formed in the light receiving region 171. In this case, an area of the circuit region 172 can be reduced, or functions can be increased that can be implemented in the circuit region 172. Furthermore, since amplitude of a signal in Cu—Cu wiring is suppressed, power consumption can be suppressed. Depending on a required use, it is possible to adjust allocation of elements to be arranged in the light receiving region 171 and elements to be arranged in the circuit region 172.

Note that, in FIG. 6, the photodetection device 1 is implemented by using the Cu—Cu connection, but this implementation method is merely an example. For example, the photodetection device 1 may be implemented by a through silicon via (TSV) or the like. That is, a method of implementing the photodetection device 1 is not limited. Furthermore, in FIG. 5, the substrates are stacked in two layers, but the number of layers of the substrates is not limited.

According to the present embodiment described above, the input fixing unit 16 of each pixel 11 temporarily fixes the input voltage of the pulse detection unit 13 to the ground potential, whereby the input transistor 130 is turned on and the data value necessary for correction of each pixel 11 can be acquired. For that reason, the correction circuit 60 performs correction calculation using the data value, whereby the variation in the dead time among the pixels 11 can be reduced. As a result, it is possible to further improve the sensitivity characteristics under an environment of high illuminance environment. Note that the input voltage of the pulse detection unit 13 temporarily fixed by the input fixing unit 16 is not limited to the ground potential, and is only required to be a potential at which the input transistor 130 is turned on.

### First Modification

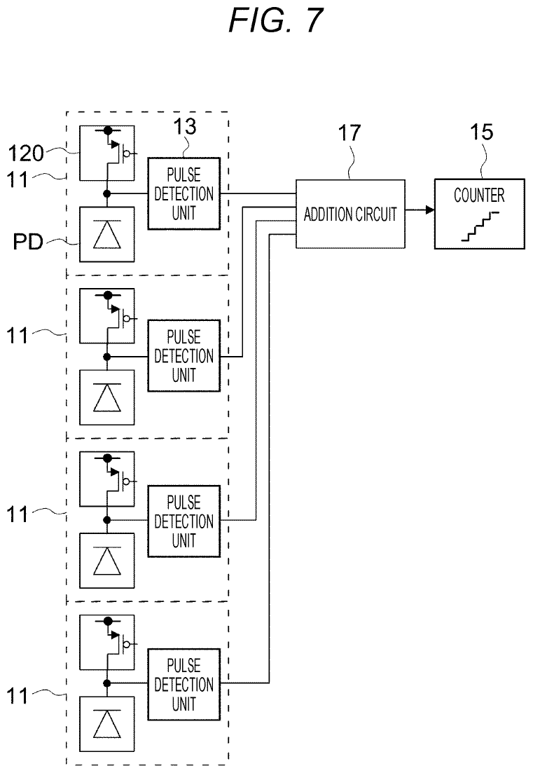

FIG. 7 is a block diagram illustrating a schematic configuration of the pixel array unit 10 according to a first modification. The pixel array unit 10 according to the present modification newly includes an addition circuit 17. The addition circuit 17 may be provided for each pixel row or each pixel column in the pixel array unit 10, for example. Furthermore, in the pixel array unit 10, one counter 15 is provided for a plurality of pixels 11. Note that, in FIG. 6, illustration is omitted of the dynamic separation switch unit 14 and the input fixing unit 16 provided in each pixel 11.

The addition circuit 17 adds together pulses output from the pulse detection units 13 of the plurality of pixels 11. The counter 15 counts the number of photons on the basis of an addition value calculated by the addition circuit 17. Also in the present modification, the input fixing unit 16 fixes pulses, the input voltage Vi2 of the detection unit 13, to the ground potential before the imaging operation, whereby the dead time td can be acquired for each pixel 11.

Thus, according to the present modification, a counter value by the counter 15 can be corrected during the imaging operation to accurately measure the number of photons of the incident light. Furthermore, since it is not necessary to provide the counter 15 in each pixel 11, it is possible to reduce a mounting area of the pixel 11.

### Second Modification

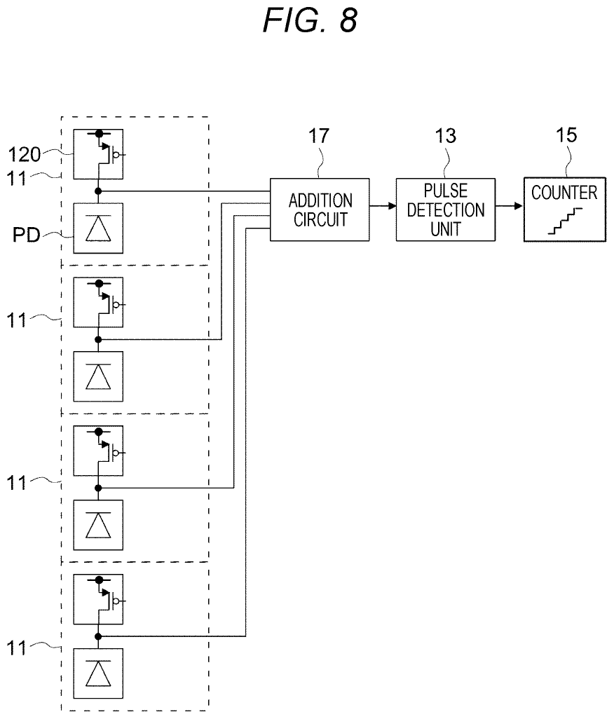

FIG. 8 is a block diagram illustrating a schematic configuration of the pixel array unit 10 according to a second modification. The pixel array unit 10 according to the present modification also newly includes the addition circuit 17 similarly to the first modification. However, in the present modification, the pulse detection unit 13 is arranged at the subsequent stage of the addition circuit 17. For that reason, one pulse detection unit 13 and one counter 15 are provided for a plurality of pixels 11. The addition circuit 17, the pulse detection unit 13, and the counter 15 may be provided for each pixel row or each pixel column in the pixel array unit 10, for example. Note that, also in FIG. 8, illustration is omitted of the dynamic separation switch unit 14 and the input fixing unit 16.

In the present modification, the addition circuit 17 adds together output signals photoelectrically converted by the photodiodes PD provided in the respective plurality of pixels 11 reacted to the photons of the incident light. The pulse detection unit 13 generates pulses on the basis of an addition value calculated by the addition circuit 17 and outputs the pulses to the counter 15. The counter 15 counts the number of photons on the basis of the pulses from the pulse detection unit 13. Also in the present modification, the input fixing unit 16 temporarily fixes pulses, the input voltage Vi2 of the detection unit 13, to the ground potential before the imaging operation, whereby the dead time td can be acquired for each pixel 11.

Thus, according to the present modification, a counter value by the counter 15 can be corrected during the imaging operation to accurately measure the number of photons of the incident light. Furthermore, since it is not necessary to provide the pulse detection unit 13 and the counter 15 in each pixel 11, it is possible to further reduce the mounting area of the pixel 11 as compared with the first modification.

### Third Modification

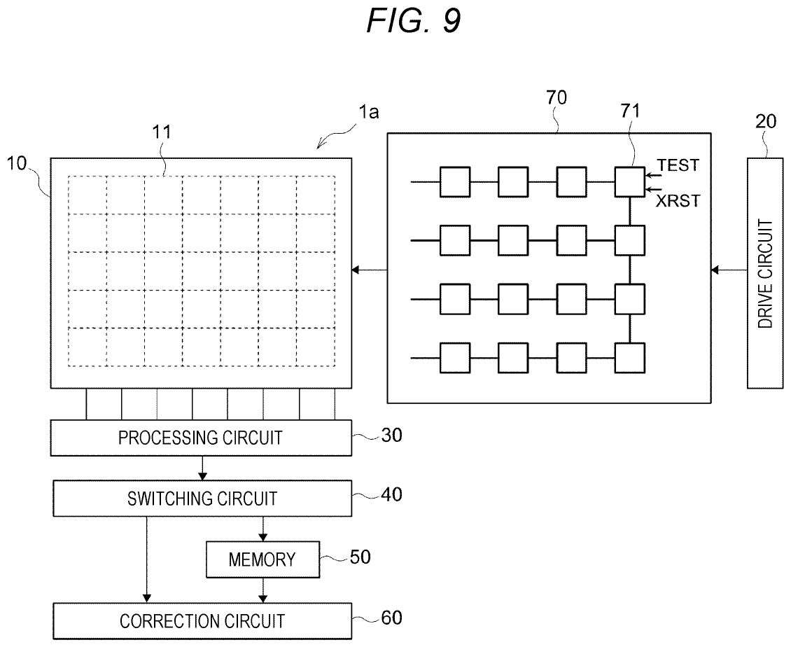

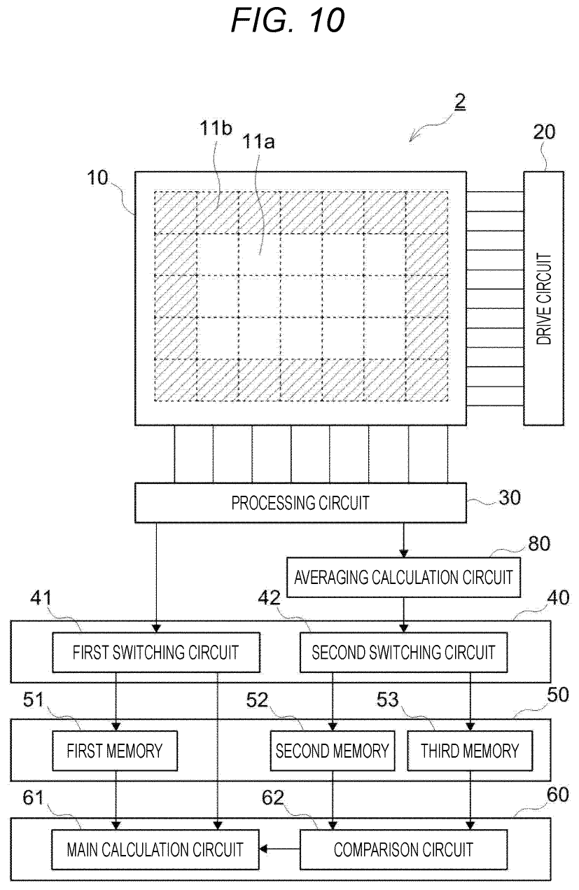

FIG. 9 is a block diagram illustrating a configuration of a photodetection device according to a third modification. A photodetection device la illustrated in FIG. 9 further includes a timing adjustment circuit 70 arranged between the pixel array unit 10 and the drive circuit 20. The timing adjustment circuit 70 is a circuit for suppressing an in-plane difference of the exposure time T generated between the pixels 11 depending on a distance from the drive circuit 20.

The timing adjustment circuit 70 includes a plurality of circuit elements 71 arranged two-dimensionally. The circuit elements 71 each are, for example, a shift register or a repeater. The repeater includes an inverter circuit including two inverter elements connected together in series. Note that the circuit element 71 may or may not have a one-to-one correspondence with the pixel 11. That is, the number of circuit elements 71 may be the same as or smaller than the number of pixels 11.

In the present modification, a signal input to an XRST terminal and the test signal TEST input to the input fixing unit 16 are transmitted from the drive circuit 20 to each pixel 11 of the pixel array unit 10 via the timing adjustment circuit 70. For that reason, the exposure time T, that is, a time from when the signal input to the XRST terminal is switched from the low level to the high level to when the test signal TEST is switched from the high level to the low level, is substantially the same timing among the pixels 11.

Thus, according to the present modification, it is possible to suppress the in-plane difference of the exposure time T in the pixel array unit 10.

### Second Embodiment

FIG. 10 is a block diagram illustrating a schematic configuration of a photodetection device according to a second embodiment. A photodetection device 2 illustrated in FIG. 10 includes the pixel array unit 10, the drive circuit 20, the processing circuit 30, the switching circuit 40, the memory 50, the correction circuit 60, and an averaging calculation circuit 80. The switching circuit 40 further includes a first switching circuit 41 and a second switching circuit 42. The memory 50 further includes a first memory 51, a second memory 52, and a third memory. The correction circuit 60 further includes a main calculation circuit 61 and a comparison circuit 62. Note that, since the drive circuit 20 and the processing circuit 30 are similar to those of the first embodiment, the description thereof will be omitted.

In the pixel array unit 10, a plurality of first pixels 11a and a plurality of second pixels 11b are two-dimensionally arranged. The first pixels 11a are each an effective pixel for measuring the count value of the photons of the incident light, and collectively arranged in a central region of the pixel array unit 10. Since a circuit configuration of each first pixel 11a is the same as that of the pixel 11 described in the first embodiment, the description thereof will be omitted.

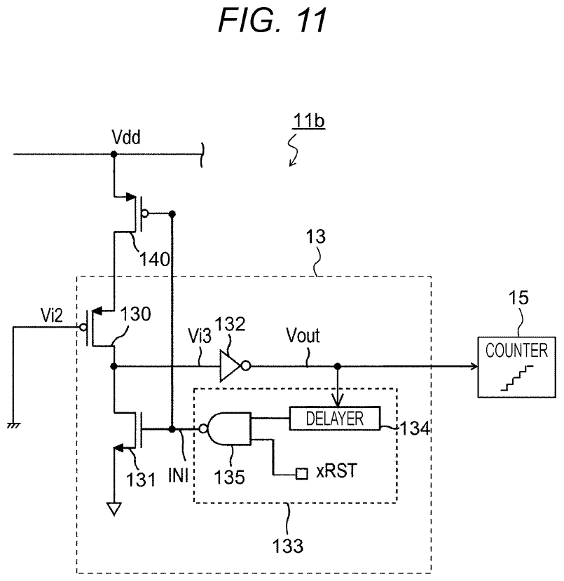

On the other hand, each second pixel 11b is a dummy pixel for correction of the count value fcnt measured in the first pixel 11a. The second pixels 11b are arranged side by side in the row direction and the column direction to surround an arrangement region of the first pixels 11a. A circuit configuration of the second pixel 11b may be the same as or different from that of the pixel 11 described above. In a case where the circuit configuration is different from that of the pixel 11 described above, the second pixel 11b may be, for example, a light-shielded pixel in which a light-receiving surface of the photodiode PD is covered with a light-shielding film. Alternatively, the second pixel 11b may have a circuit configuration not including the photodiode PD as illustrated in FIG. 11.

FIG. 11 is a diagram illustrating an example of the circuit configuration of the second pixel 11b. The circuit configuration of the second pixel 11b illustrated in FIG. 11 is different from that of the first pixel 11a in that the optical response unit 12, the inverter 141 of the dynamic separation switch unit 14, and the input fixing unit 16 are not included. In the second pixel 11b, the gate of the input transistor 130 of the pulse detection unit 13 is always fixed to the ground potential. As a result, since the count value by the counter 15 is the maximum count value, the processing circuit 30 can calculate the dead time td.

As illustrated in FIG. 10, the averaging calculation circuit 80 is arranged between the processing circuit 30 and the switching circuit 40. The averaging calculation circuit 80 calculates an average value of the dead time of the second pixel 11b calculated by the processing circuit 30.

In the switching circuit 40, the first switching circuit 41 switches an output destination of the dead time td of the first pixel 11a calculated by the processing circuit 30 to the first memory 51 of the memory 50 or the correction circuit 60 according to a state of the input fixing unit 16 of the first pixel 11a, in other words, a potential of the input voltage Vi2. Specifically, when a test signal TEST1 of the low level is input to the input fixing unit 16 of the first pixel 11a, the first switching circuit 41 outputs the dead time td to the first memory 51. Conversely, when the test signal TEST1 of the high level is input to the input fixing unit 16, the first switching circuit 41 outputs the dead time td to the main calculation circuit 61 of the correction circuit 61.

Furthermore, the second switching circuit 42 switches an output destination of the average value to the second memory 52 or the third memory 53 of the memory 50 according to a time of calculation of the average value of the dead time of the second pixel 11b in the averaging calculation circuit 80. Specifically, in a case where the averaging calculation circuit 80 calculates the average value of the dead time in the manufacturing stage described in the first embodiment, the second switching circuit 42 outputs the calculated average value to the second memory 52. On the other hand, in a case where the averaging calculation circuit 80 calculates the average value of the dead time in the imaging stage described in the first embodiment, the second switching circuit 42 outputs the calculated average value to the third memory 53.

In the memory 50, the first memory 51 stores the dead time of the first pixel 11a. Furthermore, the second memory 52 and the third memory 53 store the average value of the dead time of the second pixel 11b. Note that the second memory 52 and the third memory 53 may be configured by two memories independent of each other or may be configured by one memory. In a case where the second memory 52 and the third memory 53 are configured by one memory, the average value stored in the second memory 52 and the average value stored in the third memory are stored in different storage areas, respectively. Furthermore, the second memory 52 and the third memory 53 do not need to store the dead times td of all the second pixels 11b. For that reason, in the present embodiment, these memories may be memories having a capacity to store the average value described above, and do not need to be frame memories.

In the correction circuit 50, the main calculation circuit 61 performs correction calculation processing using a result of comparison by the comparison circuit 62. The comparison circuit 62 compares the average value stored in the second memory 52 with the average value stored in the third memory 53.

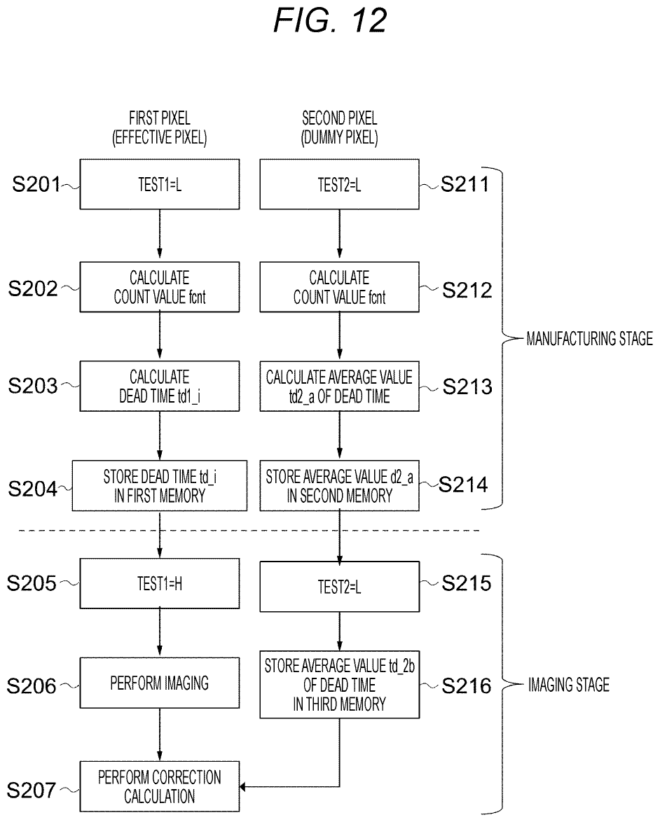

Hereinafter, a correction sequence according to the present embodiment will be described with reference to FIG. 12. FIG. 12 is a sequence diagram for explaining the correction sequence according to the second embodiment.

In the sequence illustrated in FIG. 12, first, the drive circuit 20 inputs the test signal TEST1 of the low level to the input fixing units 16 of all the first pixels 11a (step S201). As a result, the gate potential of the input transistor 130 of each first pixel 11a is fixed to the ground potential. As a result, the input voltage Vi2 (see FIG. 2) of the pulse detection units 13 of all the first pixels 11a is fixed to the ground potential.

Furthermore, simultaneously with step S201, the drive circuit 20 also inputs a test signal TEST2 of the low level to the input fixing units 16 of all the second pixels 11b (step S211). As a result, the gate potential of the input transistor 130 of each second pixel 11b is fixed to the ground potential. As a result, the input voltage Vi2 (see FIG. 2) of the pulse detection units 13 of all the second pixels 11b is also fixed to the ground potential.

Next, the counter 15 of each first pixel 11a counts the number of pulses output from the signal line Vout under the condition that the input voltage Vi2 is fixed to the ground potential, to calculate the count value fcnt of the photons (step S202). At this time, the counter 15 of each second pixel 11a also counts the number of pulses output from the signal line Vout under the condition that the input voltage Vi2 is fixed to the ground potential, to calculate the count value fcnt of the photons (step S212).

Next, as in the first embodiment, the processing circuit 30 calculates a dead time td1_i of the first pixel 11a on the basis of the count value fcnt calculated in step S202 (step S203). At this time, the processing circuit 30 also calculates a dead time td2_i of the second pixel 11b on the basis of the count value fcnt calculated in step S212.

Next, the averaging calculation circuit 80 calculates an average value td2_a of the dead time td2_i of the second pixel 11b (step S213).

Next, in the switching circuit 40, the first switching circuit 41 connects the processing circuit 30 and the first memory 51 to each other. As a result, the dead time td1_i described above is stored in the first memory 51 (step S204). At this time, the second switching circuit 42 connects the averaging calculation circuit 80 and the second memory 52 to each other. As a result, the average value td2_a described above is stored in the second memory 52 (step S214).

Operations in steps S201 to S204 and operations in steps S211 to S214 described above are performed at the manufacturing stage of the photodetection device 2, for example, at the time of the manufacturing test. Note that these operations may be performed when power is turned on to the photodetection device 2.

Subsequently, an operation at the imaging stage of the commercialized photodetection device 2 will be described.

At the imaging stage, first, the drive circuit 20 inputs the test signal TEST1 of the high level to the input fixing units 16 of all the first pixels 11a (step S205). As a result, the input fixing unit 16 connects the gate of the input transistor 130 to the cathode of the photodiode PD. At this time, the drive circuit 20 inputs the test signal TEST2 of the low level to the input fixing units 16 of all the second pixels 11b (step S215).

Next, the first pixel 11a performs imaging processing of counting the number of photons included in the light received by the photodiode PD, as in step S106 of the first embodiment (step S206). On the other hand, in the second pixel 11b, the counter 15 calculates the photo count value fcnt. Furthermore, the processing circuit 30 calculates the dead time td2_i on the basis of the calculated count value fcnt. Moreover, the averaging calculation circuit 80 calculates an average value td2_b of the dead time td2_i of the second pixel 11b.

Next, in the switching circuit 40, the first switching circuit 41 switches the connection destination of the processing circuit 30 from the first memory 51 to the main calculation circuit 61. As a result, the dead time td1_i described above calculated in step S206 is input to the main calculation circuit 61. At this time, the second switching circuit 42 switches the connection destination of the averaging calculation circuit 80 from the second memory 52 to the third memory 53. As a result, the average value td2_b described above is stored in the third memory 52 (step S216).

Next, the correction circuit 60 corrects the count value fcnt by the first pixel 11a (step S217). Here, content of calculation in step S217 will be described.

In step S217, first, the comparison circuit 62 calculates a difference between the average value td2_a stored in the second memory 52 and the average value td2_b stored in the third memory 53. Since both the average value td2_a and the average value td2_b are calculated under a condition that the test signal TEST2 is at the low level, it is considered that the average value td2_a and the average value td2_b have the same value.

However, since the average value td2_a is calculated at the manufacturing stage and the average value td2_b is calculated at the imaging stage, conditions may be different between the two average values in the applied voltage and the temperature. For that reason, the comparison circuit 62 outputs a difference between the two average values to the main calculation circuit 61 as an environmental correction coefficient.

Subsequently, the main calculation circuit 61 corrects the counter value fcnt_i·T measured in the first pixel 11a by using the dead time td1_i stored in the first memory 51, as in step S107 of the first embodiment. At this time, the main calculation circuit 61 corrects the counter value fcnt_i·T by multiplying Expression (4) used in step S107 described above by the environmental correction coefficient calculated by the comparison circuit 62.

According to the present embodiment described above, the photodetection device 2 includes the first pixels 11a that are effective pixels and the second pixels 11b that are dummy pixels, and these two types of pixels are independently controlled. Furthermore, the main calculation circuit 61 corrects the counter value measured in each first pixel 11a, whereby the variation in the dead time among the first pixels 11a can be reduced. At this time, the main calculation circuit 61 uses the environmental correction coefficient calculated by the comparison circuit 62. For that reason, it is possible to perform online correction even if the environment such as the applied voltage and the temperature dynamically changes at the imaging stage, online correction can be performed. As a result, it is possible to further improve the sensitivity characteristics.

Furthermore, in the present embodiment, the second pixels 11b are arranged along the row direction and the column direction. For that reason, shading correction in the row direction and the column direction can also be performed.

### Fourth Modification

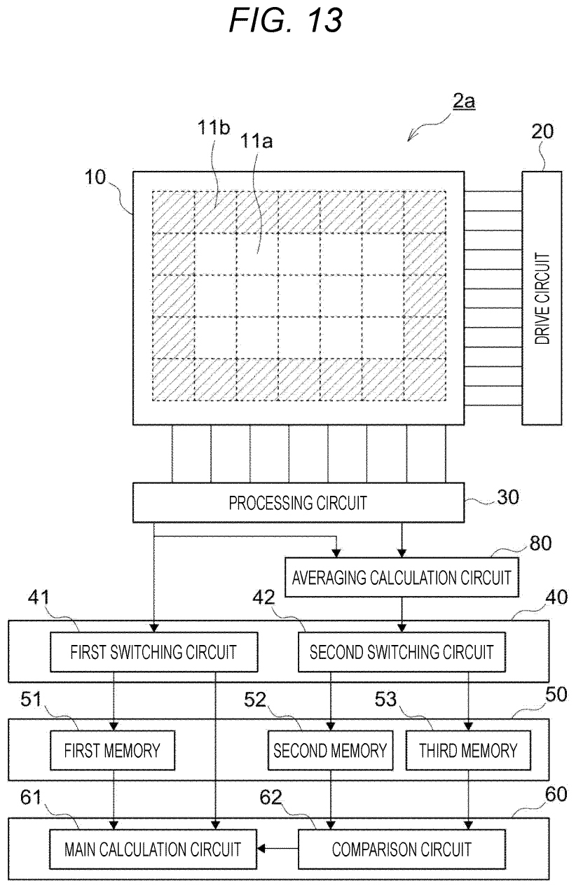

FIG. 13 is a block diagram illustrating a schematic configuration of a photodetection device according to a fourth modification. In FIG. 13, components similar to those of the second embodiment described above are denoted by the same reference signs, and a detailed description thereof will be omitted. Hereinafter, differences from the second embodiment will be mainly described.

In a photodetection device 2a according to the present modification, the averaging calculation circuit 80 calculates not only the average value of the dead time of the second pixel 11b but also an average value of the dead time of the first pixel 11a. Furthermore, the second memory 52 stores the average value of the dead time of the first pixel 11a.

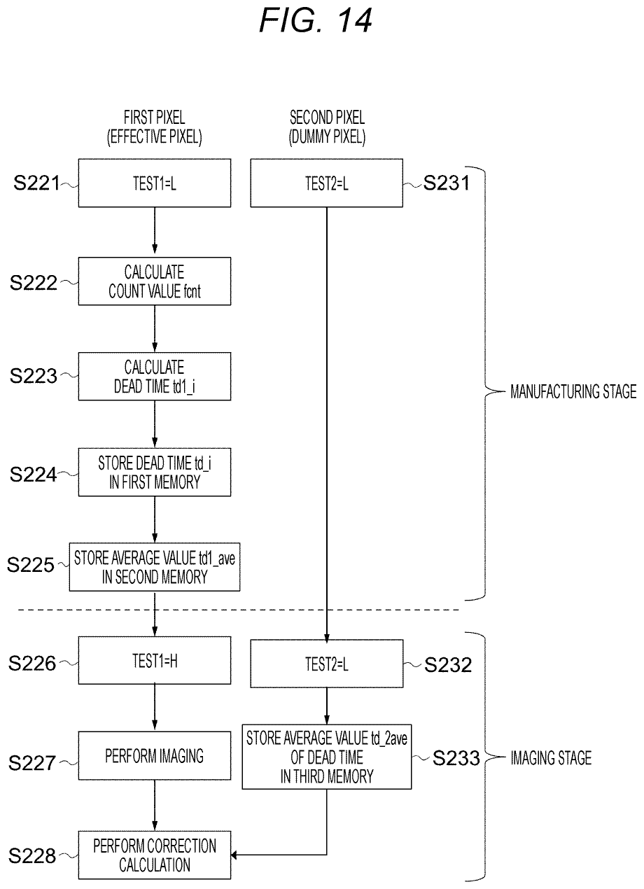

Hereinafter, a correction sequence according to the present modification will be described with reference to FIG. 14. FIG. 14 is a sequence diagram for explaining the correction sequence according to the fourth modification.

In the sequence illustrated in FIG. 14, first, the drive circuit 20 inputs the test signal TEST1 of the low level to the input fixing units 16 of all the first pixels 11a (step S221).

Next, the counter 15 of each first pixel 11a counts the number of pulses output from the signal line Vout under the condition that the input voltage Vi2 is fixed to the ground potential, to calculate the count value fcnt of the photons (step S222).

Next, the processing circuit 30 calculates the dead time td1_i of the first pixel 11a on the basis of the count value fcnt calculated in step S222 (step S223). The calculated dead time td1_i is input to each of the first switching circuit 40 and the averaging calculation circuit 80.

Next, the first switching circuit 41 connects the processing circuit 30 and the first memory 51 to each other. As a result, the dead time td1_i described above is stored in the first memory 51 (step S224).

In parallel with step S224, the averaging calculation circuit 80 calculates an average value td1_ave of the dead time td1_i input from the processing circuit 30. The calculated average value td1_ave is input to the second switching circuit 42. The second switching circuit 42 connects the averaging calculation circuit 80 and the second memory 52 to each other. As a result, the average value td1_ave described above is stored in the second memory 52 (step S225).

Operations in steps S221 to S225 described above are performed at the manufacturing stage of the photodetection device 2a or when the power is turned on. Furthermore, during the operations in steps S221 to S225, the test signal TEST2 input to the input fixing unit 16 of the second pixel 11b is set to the low level (step S231). However, the second pixel 11b does not measure the count value fcnt.

Subsequently, an operation at the imaging stage of the commercialized photodetection device 2a will be described.

At the imaging stage, first, the drive circuit 20 inputs the test signal TEST1 of the high level to the input fixing units 16 of all the first pixels 11a (step S226). As a result, the input fixing unit 16 connects the gate of the input transistor 130 to the cathode of the photodiode PD. At this time, the drive circuit 20 inputs the test signal TEST2 of the low level to the input fixing units 16 of all the second pixels 11b (step S232).

Next, the first pixel 11a performs imaging processing of counting the number of photons included in the light received by the photodiode PD (step S227). On the other hand, in the second pixel 11b, the counter 15 calculates the photo count value fcnt. Furthermore, the processing circuit 30 calculates the dead time td2_i on the basis of the calculated count value fcnt. Moreover, the averaging calculation circuit 80 calculates the average value td2_b of the dead time td2_i of the second pixel 11b. Note that, at the imaging stage, the dead time td1_i of the first pixel 11a is also input to the averaging calculation circuit 80, but the averaging calculation circuit 80 is configured not to calculate the average value of the dead time td1_i.

Next, in the switching circuit 40, the first switching circuit 41 switches the connection destination of the processing circuit 30 from the first memory 51 to the main calculation circuit 61. As a result, the dead time td1_i described above calculated in step S227 is input to the main calculation circuit 61. At this time, the second switching circuit 42 switches the connection destination of the averaging calculation circuit 80 from the second memory 52 to the third memory 53. As a result, the average value td2_b described above is stored in the third memory 52 (step S233).

Next, the correction circuit 60 corrects the count value fcnt by the first pixel 11a (step S228). Here, content of calculation in step S228 will be described.

In step S228, first, the comparison circuit 62 calculates a difference between the average value td1_ave of the first pixel 11a stored in the second memory 52 and the average value td2_b of the second pixel 11b stored in the third memory 53. Since manufacturing processes for the first pixel 11a and the second pixel 11b are the same, it is considered that the average value td1_ave and the average value td2_b have the same value calculated under a condition that both the test signal TEST1 and the test signal TEST2 are at the low level.

However, since the average value td1_ave is calculated at the manufacturing stage and the average value td2_b is calculated at the imaging stage, conditions may be different between the two average values in the applied voltage and the temperature. For that reason, in the present modification, the comparison circuit 62 outputs a difference between the average value td1_ave and the average value td2_b to the main calculation circuit 61 as an environmental correction coefficient.

The main calculation circuit 61 corrects the counter value fcnt_i·T measured in the first pixel 11a by using the dead time td1_i stored in the first memory 51, as in step S107 of the first embodiment. At this time, the main calculation circuit 61 corrects the counter value fcnt_i·T by multiplying Expression (4) used in step S107 described above by the environmental correction coefficient calculated by the comparison circuit 62.

According to the present modification described above, as in the second embodiment described above, the main calculation circuit 61 corrects the counter value measured in each first pixel 11a, whereby the variation in the dead time among the first pixels 11a can be reduced. At this time, the main calculation circuit 61 uses the environmental correction coefficient calculated by the comparison circuit 62. In the present modification, the environmental correction coefficient is calculated by a difference between the average value td1_ave at the manufacturing stage and the average value td2_b at the imaging stage. For that reason, also in the present modification, it is possible to perform online correction even if the environment such as the applied voltage and the temperature dynamically changes at the imaging stage. As a result, it is possible to further improve the sensitivity characteristics.

Moreover, also in the present modification, the second pixels 11b are arranged along the row direction and the column direction. For that reason, shading correction in the row direction and the column direction can also be performed.

### Fifth Modification

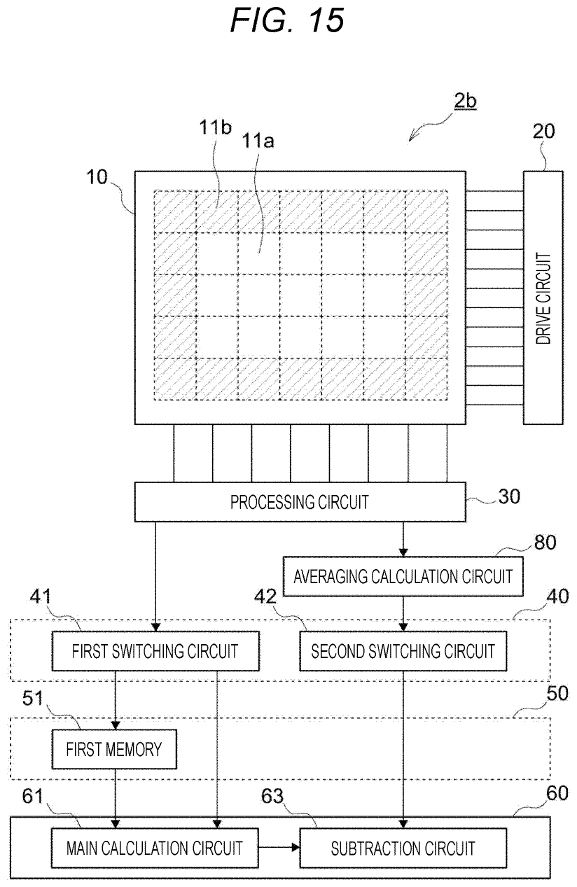

FIG. 15 is a block diagram illustrating a schematic configuration of a photodetection device according to a fifth modification. In FIG. 15, components similar to those of the second embodiment described above are denoted by the same reference signs, and a detailed description thereof will be omitted. Hereinafter, differences from the second embodiment will be mainly described.

In a photodetection device 2b according to the present modification, the second pixel 11b is a light-shielded pixel for which incident light is shielded. Furthermore, the memory 50 includes only the first memory 51 and does not include the second memory 52 and the third memory 53. Furthermore, the correction circuit 60 includes a subtraction circuit 63 instead of the comparison circuit 62. Moreover, in the switching circuit 40, the second switching circuit 42 switches whether or not to connect the averaging calculation circuit 80 and the subtraction circuit 63 to each other.

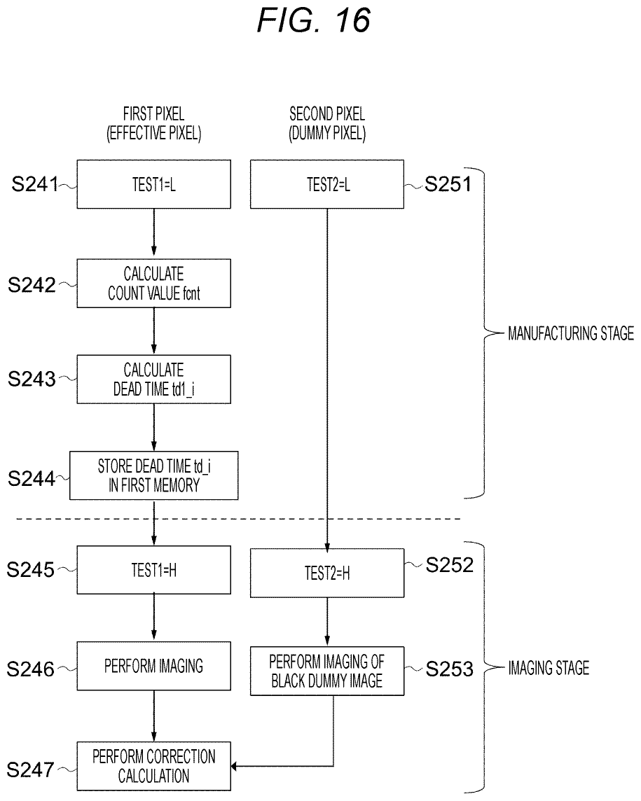

Hereinafter, a correction sequence according to the present modification will be described with reference to FIG. 16. FIG. 16 is a sequence diagram for explaining the correction sequence according to the fifth modification.

In the sequence illustrated in FIG. 16, first, the drive circuit 20 inputs the test signal TEST1 of the low level to the input fixing units 16 of all the first pixels 11a (step S241).

Next, the counter 15 of each first pixel 11a counts the number of pulses output from the signal line Vout under the condition that the input voltage Vi2 is fixed to the ground potential, to calculate the count value fcnt of the photons (step S242).

Next, the processing circuit 30 calculates the dead time td1_i of the first pixel 11a on the basis of the count value fcnt calculated in step S242 (step S243).

Next, the first switching circuit 41 connects the processing circuit 30 and the first memory 51 to each other. As a result, the dead time td1_i described above is stored in the first memory 51 (step S244).

Operations in steps S241 to S244 described above are performed at the manufacturing stage of the photodetection device 2b or when the power is turned on. Furthermore, during the operations in steps S241 to S244, the test signal TEST2 input to the input fixing unit 16 of the second pixel 11b is set to the low level (step S241). However, the second pixel 11b does not measure the count value fcnt.

Subsequently, an operation at the imaging stage of the commercialized photodetection device 2b will be described.

At the imaging stage, first, the drive circuit 20 inputs the test signal TEST1 of the high level to the input fixing units 16 of all the first pixels 11a (step S245). As a result, the input fixing unit 16 connects the gate of the input transistor 130 to the cathode of the photodiode PD. At this time, the drive circuit 20 inputs the test signal TEST2 of the low level to the input fixing units 16 of all the second pixels 11b (step S252).

Next, the first pixel 11a performs imaging processing of counting the number of photons included in the light received by the photodiode PD (step S246). In step S246, the processing circuit 30 calculates the dead time td1_i on the basis of the count value fcnt by the first pixel 11a. Subsequently, next, the first switching circuit 41 switches the connection destination of the processing circuit 30 from the first memory 51 to the main calculation circuit 61. As a result, the dead time td1_i described above is input to the main calculation circuit 61.

On the other hand, in parallel with step S246, in the second pixel 11b, imaging processing is performed of a black dummy image including a dark current component (step S253). In the present modification, the second pixel 11b is a light-shielded pixel as described above. For that reason, in step S253, the counter value calculated by the counter 15 of the second pixel 11b does not include a light current component corresponding to the number of photons of the incident light. On the other hand, the counter value described above may include a noise component generated by a manufacturing variation of a transistor or the like provided in the second pixel 11b. The noise component is included in the black dummy image as a dark current component. The dark current component is also included in an imaged image by the first pixel 11a.

Furthermore, in step S253, the processing circuit 30 calculates the dead time td2_i of the second pixel 11b. Subsequently, the averaging calculation circuit 80 calculates the average value td2_b of the dead time td2_i. Subsequently, the second switching circuit 42 connects the averaging calculation circuit 80 and the subtraction circuit 63 to each other. As a result, the average value td2_b is input to the subtraction circuit 63. Note that the average value td2_b also includes a dark current component.

Following the imaging processing by the first pixel 11a and the black dummy image imaging processing by the second pixel 11b described above, the correction circuit 60 corrects the count value fcnt by the first pixel 11a (step S247). In step S247, first, the main calculation circuit 61 corrects the counter value fcnt_i·T measured in the first pixel 11a by using the dead time td1_i stored in the first memory 51, as in step S107 of the first embodiment. However, a calculated value by the main calculation circuit 61 includes a dark current component.

Thus, in step S247, the subtraction circuit 63 subtracts the average value td2_b from the calculated value by the main calculation circuit 61. As a result, the dark current component (noise component) is removed from the calculated value by the main calculation circuit 61.

According to the present modification described above, the dark current component can be removed from a result of measurement in the first pixel 11a. For that reason, the photons of the incident light can be measured with higher accuracy.

### Sixth Modification

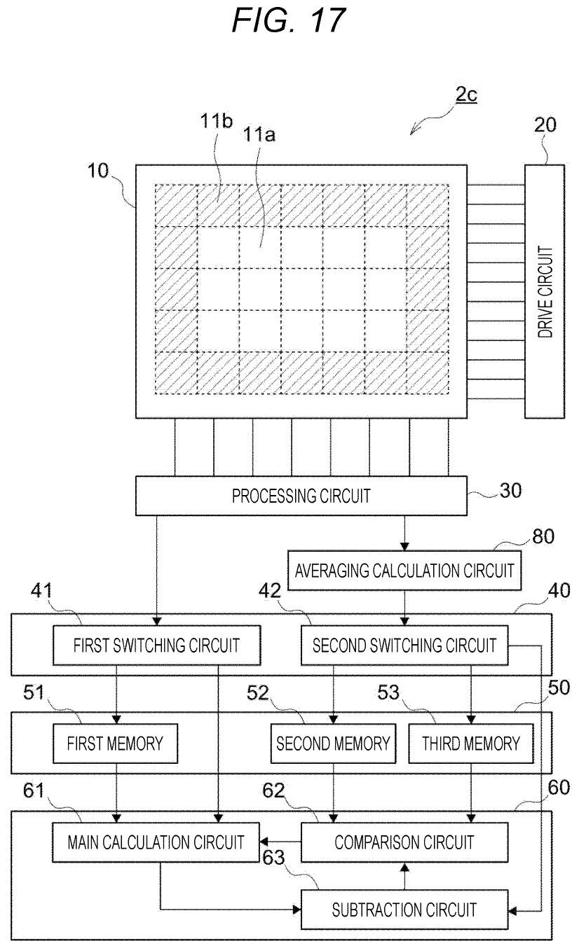

FIG. 17 is a block diagram illustrating a schematic configuration of a photodetection device according to a sixth modification. In FIG. 17, components similar to those of the second embodiment described above are denoted by the same reference signs, and a detailed description thereof will be omitted. In a photodetection device 2c according to the present modification, the correction circuit 60 includes the subtraction circuit 63 described in the fifth modification in addition to the main calculation circuit 61 and the comparison circuit 62.

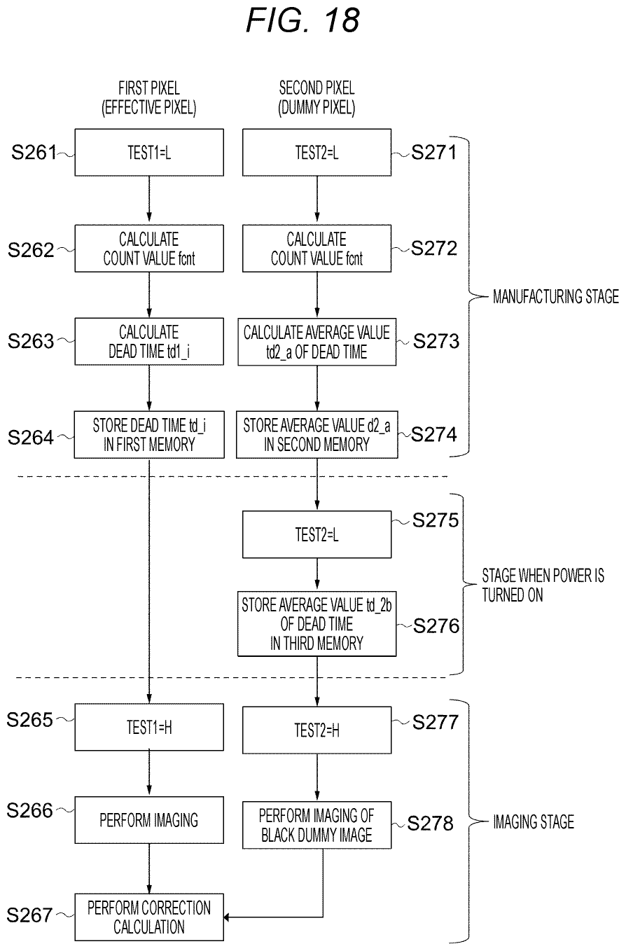

Hereinafter, a correction sequence according to the present modification will be described with reference to FIG. 18. FIG. 18 is a sequence diagram for explaining the correction sequence according to the sixth modification.

In the sequence illustrated in FIG. 18, first, the drive circuit 20 inputs the test signal TEST1 of the low level to the input fixing units 16 of all the first pixels 11a (step S261). Furthermore, simultaneously with step S261, the drive circuit 20 also inputs the test signal TEST2 of the low level to the input fixing units 16 of all the second pixels 11b (step S271).

Next, the counter 15 of each first pixel 11a calculates the count value fcnt of the photons (step S262). At this time, the counter 15 of each second pixel 11a also calculates the count value fcnt of the photons (step S272).

Next, the processing circuit 30 calculates the dead time td1_i of the first pixel 11a on the basis of the count value fcnt calculated in step S262 (step S263). At this time, the processing circuit 30 also calculates the dead time td2_i of the second pixel 11b on the basis of the count value fcnt calculated in step S272.

Next, the averaging calculation circuit 80 calculates the average value td2_a of the dead time td2_i of the second pixel 11b (step S273).

Next, the first switching circuit 41 connects the processing circuit 30 and the first memory 51 to each other. As a result, the dead time td1_i described above is stored in the first memory 51 (step S264). At this time, the second switching circuit 42 connects the averaging calculation circuit 80 and the second memory 52 to each other. As a result, the average value td2_a described above is stored in the second memory 52 (step S274).

Operations in steps S261 to S264 and operation in steps S271 to S274 described above are performed at the manufacturing stage of the photodetection device 2c, for example, at the time of the manufacturing test.

Subsequently, an operation at a stage when the power is turned on to the commercialized photodetection device 2 will be described.

At the stage when the power is turned on, first, the drive circuit 20 inputs the test signal TEST2 of the low level to the input fixing units 16 of all the second pixels 11b (step S275).

Next, the counter 15 of the second pixel 11b calculates the photo count value fcnt. Subsequently, the processing circuit 30 calculates the dead time td2_i on the basis of the calculated count value fcnt. Subsequently, the averaging calculation circuit 80 calculates the average value td2_b of the dead time td2_i of the second pixel 11b. Subsequently, the second switching circuit 42 switches the connection destination of the averaging calculation circuit 80 from the second memory 52 to the third memory 53. As a result, the average value td2_b described above is stored in the third memory 52 (step S276).

Subsequently, an operation of the imaging stage of the photodetection device 2c after the power is turned on will be described.

In the imaging stage, first, the drive circuit 20 inputs the test signal TEST1 of the high level to the input fixing units 16 of all the first pixels 11a (step S265). At this time, the drive circuit 20 also inputs the test signal TEST2 of the high level to the input fixing units 16 of all the second pixels 11b (step S277).

Next, the first pixel 11a performs imaging processing of counting the number of photons included in the light received by the photodiode PD (step S266). In parallel with step S266, in the second pixel 11b, the imaging processing of the black dummy image is performed as in step S253 of the fifth modification (step S278). In step S278 of the present modification, the second switching circuit 42 switches the connection destination of the averaging calculation circuit 80 from the third memory 53 to the subtraction circuit 63. For that reason, an average value td2_ave of the dead time of the second pixel 11b calculated by the averaging calculation circuit 80 at the imaging stage is input to the subtraction circuit 63.

Next, the correction circuit 60 corrects the count value fcnt by the first pixel 11a (step S267). In step S267, first, the comparison circuit 62 calculates a difference between the average value td1_ave of the first pixel 11a stored in the second memory 52 and the average value td2_b of the second pixel 11b stored in the third memory 53 as an environmental correction coefficient.

Subsequently, the main calculation circuit 61 corrects the counter value fcnt_i·T measured in the first pixel 11a by using the dead time td1_i stored in the first memory 51. At this time, as in the second embodiment, the main calculation circuit 61 corrects the counter value fcnt_i·T by using the environmental correction coefficient calculated by the comparison circuit 62.

Subsequently, the subtraction circuit 63 subtracts the average value td2_ave of the second pixel 11b from the calculated value by the main calculation circuit 61. As a result, the dark current component (noise component) is removed from the calculated value by the main calculation circuit 61.

According to the present modification described above, the environmental correction coefficient corresponding to an environmental change is calculated by the comparison circuit 62, and the dark current component is removed from the result of measurement by the first pixel 11a by the subtraction circuit 63. As a result, it is possible to measure photons with high accuracy while improving the sensitivity characteristics.

### Seventh Modification

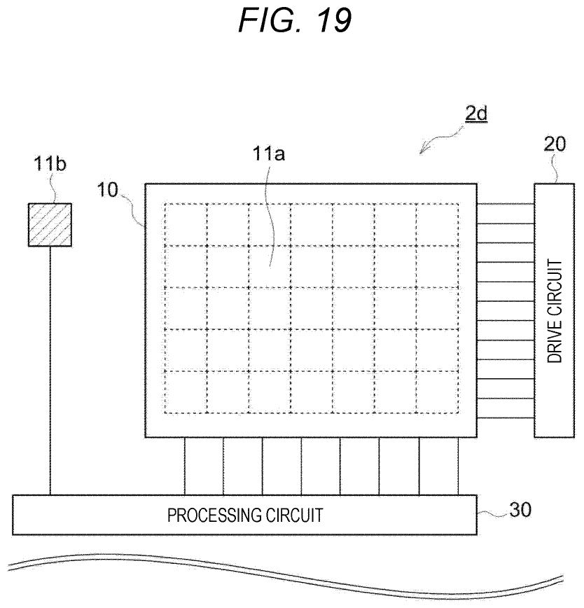

FIG. 19 is a block diagram illustrating a schematic configuration of a photodetection device according to a seventh modification. In FIG. 19, components similar to those of the second embodiment described above are denoted by the same reference signs, and a detailed description thereof will be omitted. Furthermore, in FIG. 19, a circuit configuration on the subsequent stage side of the processing circuit 30 is similar to that of the second embodiment or the fourth modification to the sixth modification, and thus illustration thereof is omitted.

In a photodetection device 2d according to the present modification, the second pixel 11b is arranged on a substrate (chip) different from that for the first pixel 11a. For example, in a case where the first pixel 11a is arranged on the substrate 161 (see FIG. 6) described in the first embodiment, the second pixel 11b is arranged on the substrate 162 (see FIG. 6) stacked with the substrate 161.

Even if the first pixel 11a and the second pixel 11b are arranged as described above, the correction sequence described in the second embodiment and the fourth to sixth modifications is performed, whereby the count value of the photons measured by the first pixel 11a can be corrected. For that reason, also in the present modification, the sensitivity characteristics can be improved.

Moreover, in the present modification, all the pixels of the pixel array unit 11 are configured by the first pixels 11a. As a result, since the light receiving region is enlarged, the sensitivity characteristics can be further improved.

### Eighth Modification

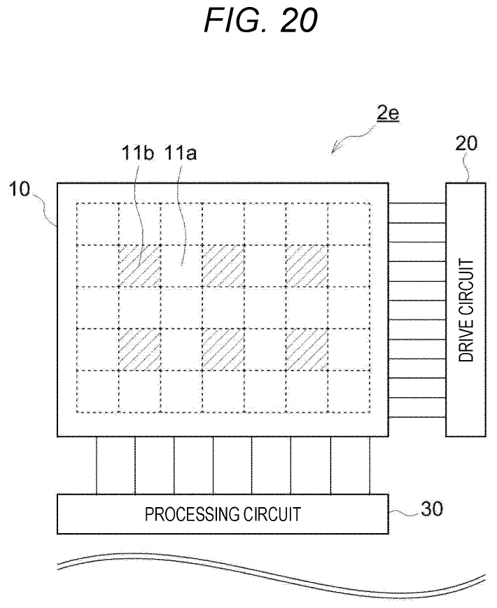

FIG. 20 is a block diagram illustrating a schematic configuration of a photodetection device according to an eighth modification. In FIG. 20, components similar to those of the second embodiment described above are denoted by the same reference signs, and a detailed description thereof will be omitted. Furthermore, in FIG. 20, a circuit configuration on the subsequent stage side of the processing circuit 30 is similar to that of the second embodiment or the fourth modification to the sixth modification, and thus illustration thereof is omitted.

In a photodetection device 2e according to the present modification, the second pixels 11b are arranged in a distributed manner in the pixel array unit 10. For example, in FIG. 20, the first pixel 11a and the second pixel 11b are alternately arranged in the row direction and the column direction.

Even if the first pixel 11a and the second pixel 11b are arranged as described above, the correction sequence described in the second embodiment and the fourth to sixth modifications is performed, whereby the count value of the photons measured by the first pixel 11a can be corrected. Thus, the sensitivity characteristics can be improved.

Moreover, in the present modification, since the second pixels 11b are arranged in a distributed manner, in-plane shading correction of the pixel array unit 10 can be performed.

### Third Embodiment

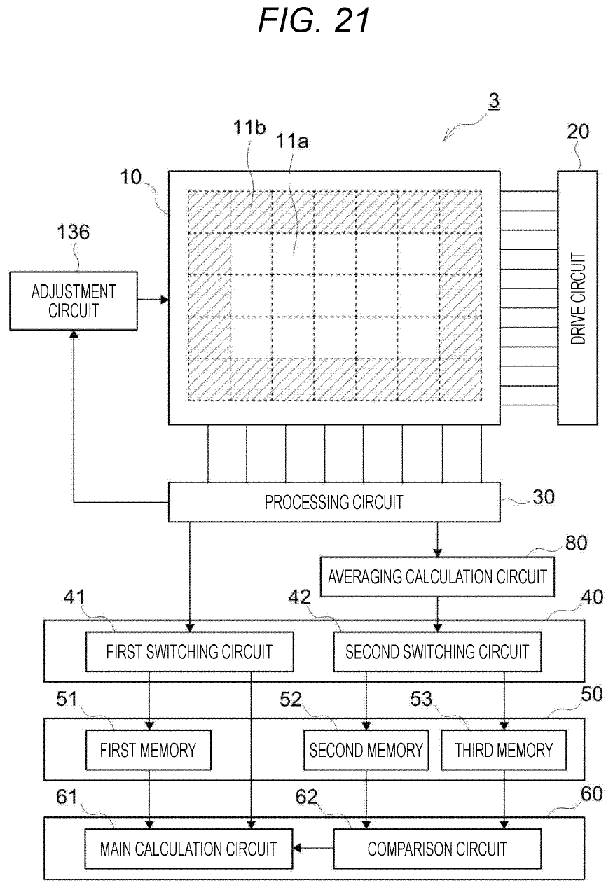

FIG. 21 is a block diagram illustrating a schematic configuration of a photodetection device according to a third embodiment. In FIG. 20, components similar to those of the second embodiment described above are denoted by the same reference signs, and a detailed description thereof will be omitted.

A photodetection device 3 according to the present embodiment further includes an adjustment circuit 136 in addition to the components of the photodetection device 2 according to the second embodiment. The adjustment circuit 136 adjusts the delay time of the delayer 134 of the first pixel 11a before the imaging stage. Output of the pulse from the pulse detection unit 13 to the counter 15 can be adjusted by the delay time of the delayer 134. The delay time corresponds to the dead time td1_i of the first pixel 11a. That is, as the delay time of the delayer 134 becomes longer, the dead time also becomes longer. For that reason, the adjustment circuit 136 optimizes the dead time td1_i of the first pixel 11a by adjusting the delay time of the delayer 134. Note that the adjustment circuit 136 may be built in the delayer 134 or may be externally attached.

In a case where the delayer 134 has, for example, the circuit configuration illustrated in FIG. 3B, at least one of the resistance values of the resistance elements 313 and 314 or the capacitance values of the capacitance elements 315 and 316 is variable. For that reason, the adjustment circuit 136 can adjust the delay time by changing at least one of the resistance value or the capacitance value.

Furthermore, in a case where the delayer 134 has the circuit configuration illustrated in FIG. 3C, the adjustment circuit 136 can adjust the delay time by changing the voltage of the bias signal BIAS_P. Moreover, in a case where the delayer 134 has the circuit configuration illustrated in FIG. 3D, the adjustment circuit 136 can adjust the delay time by changing the voltage of the bias signal BIAS_N.

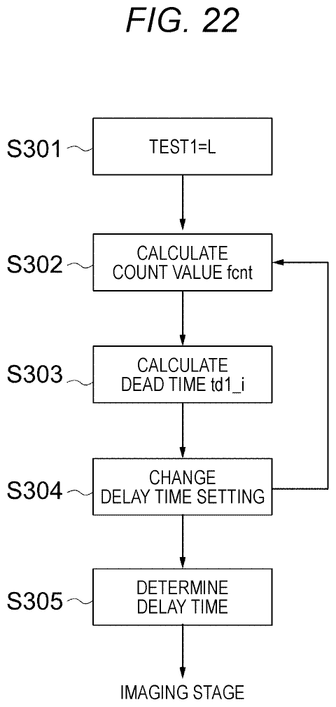

The adjustment circuit 136 determines an optimal delay time on the basis of the dead time td1_i calculated by the processing circuit 30 each time the delay time of the delayer 134 is changed. Here, delay time optimization processing will be described with reference to FIG. 22.

FIG. 22 is a sequence diagram of the delay time optimization processing. In the sequence diagram illustrated in FIG. 22, first, the drive circuit 20 inputs the test signal TEST1 of the low level to the input fixing units 16 of all the first pixels 11a (step S301). At this time, the delay time of the delayer 134 of each first pixel 11a is set to a lower limit value within an adjustment range set in advance.

Next, the counter 15 of the first pixel 11a calculates the count value fcnt (step S302).

Next, the processing circuit 30 calculates the dead time td1_i on the basis of the count value fcnt calculated in step S302 (step S303).

Next, the adjustment circuit 136 changes the delay time from the lower limit value (step S304). In step S304, the adjustment circuit 136 increases the delay time by, for example, a predetermined step width. When the delay time is changed, the processing returns to step S302 again, and the counter 15 of the first pixel 11a calculates the count value fcnt based on the changed delay time. As described above, the processing of steps S302 to S304 is repeated until a changed value of the delay time of the delayer 134 reaches an upper limit value within the adjustment range.

Next, the adjustment circuit 146 determines the optimal delay time within the adjustment range (step S305). In the photodetection device 3 according to the present embodiment, as the variation in the dead time td1_i among the first pixels 11a decreases, accuracy of photo counting increases. For that reason, in step S305, the adjustment circuit 146 determines, as the optimal delay time, a delay time at which a difference between a minimum value and a maximum value of the dead time is minimized among the first pixels 11a. Thereafter, an operation of the imaging stage is performed with the determined delay time. Since the operation content of the imaging stage is similar to that of the second embodiment, the description thereof will be omitted.

According to the present embodiment described above, as in the second embodiment described above, the main calculation circuit 61 corrects the counter value measured in each first pixel 11a, whereby the variation in the dead time among the first pixels 11a can be reduced. At this time, the main calculation circuit 61 uses the environmental correction coefficient calculated by the comparison circuit 62, whereby it is possible to perform online correction even if the environment such as the applied voltage and the temperature dynamically changes at the imaging stage.

Moreover, in the present embodiment, the adjustment circuit 136 optimizes the delay time of the delayer 134 of the first pixel 11a, whereby the variation in the dead time among the first pixels 11a can be further reduced.

### Fourth Embodiment

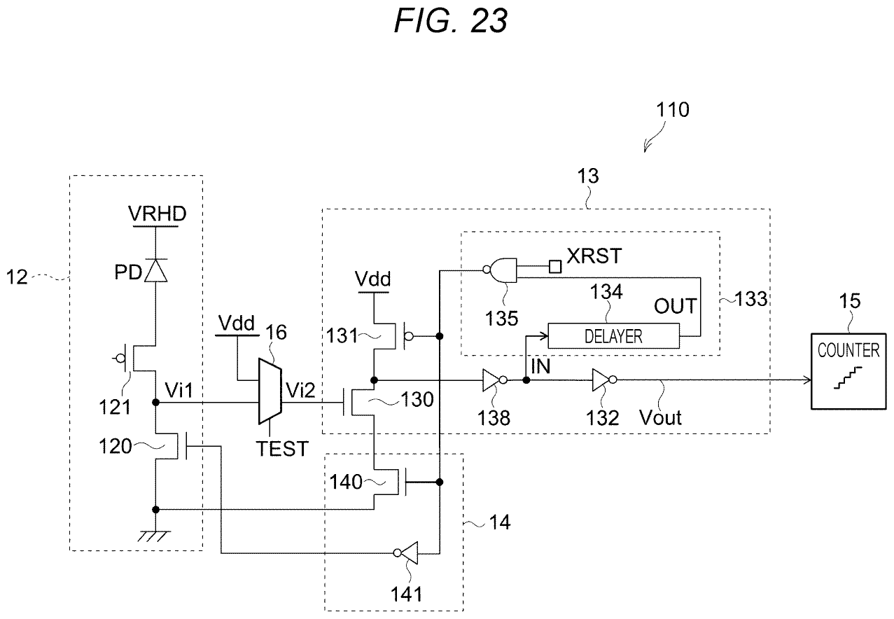

FIG. 23 is a diagram illustrating an example of a circuit configuration of a pixel according to a fourth embodiment. Circuit elements similar to those of the pixel 11 according to the first embodiment described above are denoted by the same reference signs, and redundant description will be omitted. In the pixel 11 illustrated in FIG. 2, the cathode of the photodiode PD is an output terminal of the optical response unit 12. On the other hand, in a pixel 110 according to the present embodiment, the anode of the photodiode PD is the output terminal of the optical response unit 12.

Furthermore, in the optical response unit 12 of the pixel 110, the transistor 120 is an N-channel MOS transistor. Moreover, a P-channel MOS transistor 121 is arranged between the photodiode PD and the transistor 120. The MOS transistor 121 is turned on or off under the control of the drive circuit 20. When the MOS transistor 121 is turned on, the anode of the photodiode PD is connected to the input fixing unit 16 via the MOS transistor 121.

In the pulse detection unit 13 of the pixel 110, while the input transistor 130 is an N-channel MOS transistor, the transistor 131 is a P-channel MOS transistor. Furthermore, an inverter 138 is further arranged between the drain of the input transistor and the inverter 132.

In the dynamic separation switch unit 14 of the pixel 110, the transistor 140 is an N-channel MOS transistor.

One input terminal of the input fixing unit 16 of the pixel 110 is connected to the optical response unit 12 via the signal line Vi1. The other input terminal of the input fixing unit 16 is fixed to the power supply potential Vdd.

In the pixel 110 of the present embodiment configured as described above, the input fixing unit 16 of each pixel 110 temporarily fixes the input voltage of the pulse detection unit 13 to the power supply potential Vdd, whereby the input transistor 130 is turned on and a data value necessary for correction of each pixel 110 can be acquired. For that reason, as in the first embodiment, the correction circuit 60 performs correction calculation using the data value, whereby the variation in the dead time among the pixels 110 can be reduced. As a result, it is possible to further improve the sensitivity characteristics under an environment of high illuminance environment. Note that, in the present embodiment, the input voltage of the pulse detection unit 13 temporarily fixed by the input fixing unit 16 is not limited to the power supply potential Vdd, and is only required to be a potential at which the input transistor 130 is turned on. Furthermore, the circuit configuration of the pixel 110 according to the present embodiment may be applied to the second embodiment and each modification described above.

### Fifth Embodiment

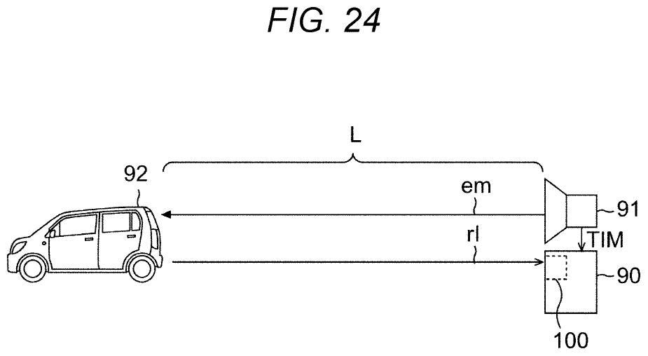

FIG. 24 is a diagram schematically illustrating an example of distance measurement using a photodetection device. FIG. 24 illustrates a case where a distance to an object 92 is obtained by using a light source 91 and a distance measuring device 90. The light source 91 emits light em toward the object 92. The distance measuring device 90 detects reflected light rl of the light em on the object 92 by the photodetection device 1. The object 92 illustrated in FIG. 2 is an automobile, but the type of the object is not limited.

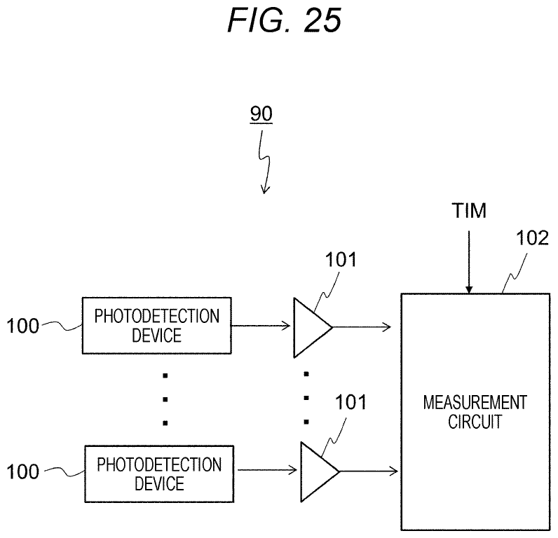

FIG. 25 is a block diagram illustrating a schematic configuration of the distance measuring device 90. The distance measuring device 90 illustrated in FIG. 25 includes a photodetection device 100, a buffer 101, and a measurement circuit 102.

Any of the photodetection devices 1 to 3 according to the embodiments described above can be applied to the photodetection device 100. The measurement circuit 102 is connected to the subsequent stage of the photodetection device 100 via the buffer 101. The buffer 101 is also referred to as a sampler circuit, and digitizes a signal output from the photodetection device 100. In the present embodiment, as illustrated in FIG. 25, a plurality of the photodetection devices 100 and the buffers 101 may be connected to the measurement circuit 102.

The measurement circuit 102 includes, for example, a time to digital converter (TDC) and a histogram generator. The TDC measures a time from a light irradiation time to a photon incidence time on the basis of information regarding the light irradiation time input from a signal line TIM. The time corresponds to a time of flight (ToF) until the light em emitted from the light source 91 is reflected by the object 92 and returns to the distance measuring device 90. The histogram generator accumulates results of measurement of the time of flight over a plurality of times and generates a histogram. By measuring the time of flight over the plurality of times, it is possible to identify background light (disturbance light) and the reflected light rl of the light emitted from the light source 91. At the time of generating the histogram, calculation may be performed such as averaging the results of measurement of the time of flight over the plurality of times. By obtaining a peak of the histogram, it is possible to calculate the distance between the photodetection device 100 and the object 92.

The measurement circuit 102 can be implemented by, for example, a hardware circuit such as a field programmable gate array (FPGA) or an application specific integrated circuit (ASIC). However, a function of the measurement circuit 102 may be implemented by a central processing unit (CPU) and a program executed on the CPU. The measurement circuit 102 may include a memory or a storage that stores a program and data necessary for executing the program.

According to the present embodiment described above, since the sensitivity characteristics of the photodetection device 100 is improved, distance measurement accuracy can be improved.

### Sixth Embodiment

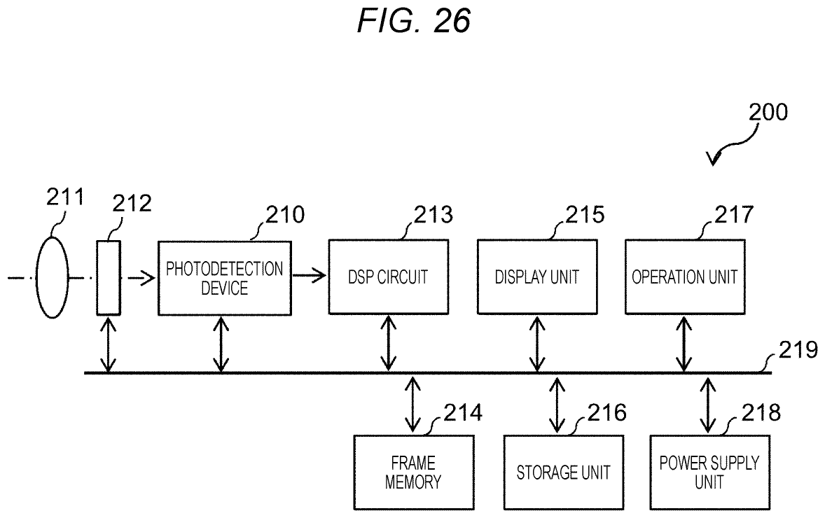

FIG. 26 is a block diagram illustrating a schematic configuration of an electronic device according to a sixth embodiment. An electronic device 200 in FIG. 26 is an electronic device, for example, an imaging device such as a digital still camera or a video camera, or a portable terminal device such as a smartphone or a tablet terminal.

The electronic device 200 includes, for example, a photodetection device 210, an optical system 211, a shutter device 212, a DSP circuit 213, a frame memory 214, a display unit 215, a storage unit 216, an operation unit 217, and a power supply unit 218. In the electronic device 200, the photodetection device 210, the shutter device 212, the DSP circuit 213, the frame memory 214, the display unit 215, the storage unit 216, the operation unit 217, and the power supply unit 218 are connected to each other via a bus line 219.

Any of the photodetection devices 1 to 3 according to the embodiments described above can be applied to the photodetection device 210. The optical system 211 includes one or a plurality of lenses, guides light (incident light) from a subject to the photodetection device 210, and forms an image on a light-receiving surface of the photodetection device 210.

The shutter device 212 is arranged between the optical system 211 and the photodetection device 210, and controls a light irradiation period and a light shielding period for the photodetection device 210. The DSP circuit 213 is a signal processing circuit that processes an output signal of the photodetection device 210. The frame memory 214 temporarily holds image data processed by the DSP circuit 213 in units of frames.

The display unit 215 includes, for example, a panel display device such as a liquid crystal panel or an organic electro luminescence (EL) panel, and displays a moving image or a still image imaged by the photodetection device 210. The storage unit 216 records image data of the moving image or the still image imaged by the photodetection device 210 in a recording medium such as a semiconductor memory or a hard disk.

The operation unit 217 issues operation commands for various functions of the electronic device 200 in accordance with operation by a user. The power supply unit 218 appropriately supplies various power sources serving as operation power sources of the photodetection device 210, the shutter device 212, the DSP circuit 213, the frame memory 214, the display unit 215, the storage unit 216, and the operation unit 217 to these supply targets.

In the electronic device 200 configured as described above, when the user gives an instruction to start imaging by operating the operation unit 217, the operation unit 217 transmits an imaging command to the photodetection device 210. When receiving the imaging command, the photodetection device 210 performs various settings (for example, the image quality adjustment described above and the like). Subsequently, the photodetection device 210 executes imaging by a predetermined imaging method.

The photodetection device 210 outputs a signal obtained by imaging to the DSP circuit 213. The DSP circuit 213 performs predetermined signal processing (for example, noise reduction processing or the like) on the output signal of the photodetection device 210. The DSP circuit 213 causes the frame memory 214 to hold the image data subjected to predetermined signal processing, and the frame memory 214 causes the storage unit 216 to store the image data. In this way, imaging in the electronic device 200 is performed.

In the photodetection device 210 according to the present embodiment, as in the first embodiment described above,

### Application Example to Mobile Body

The technology according to the present disclosure (the present technology) can be applied to various products. For example, the technology according to the present disclosure may be implemented as a device mounted on any type of mobile bodies, such as an automobile, an electric automobile, a hybrid electric automobile, a motorcycle, a bicycle, personal mobility, an airplane, a drone, a ship, a robot, and the like.

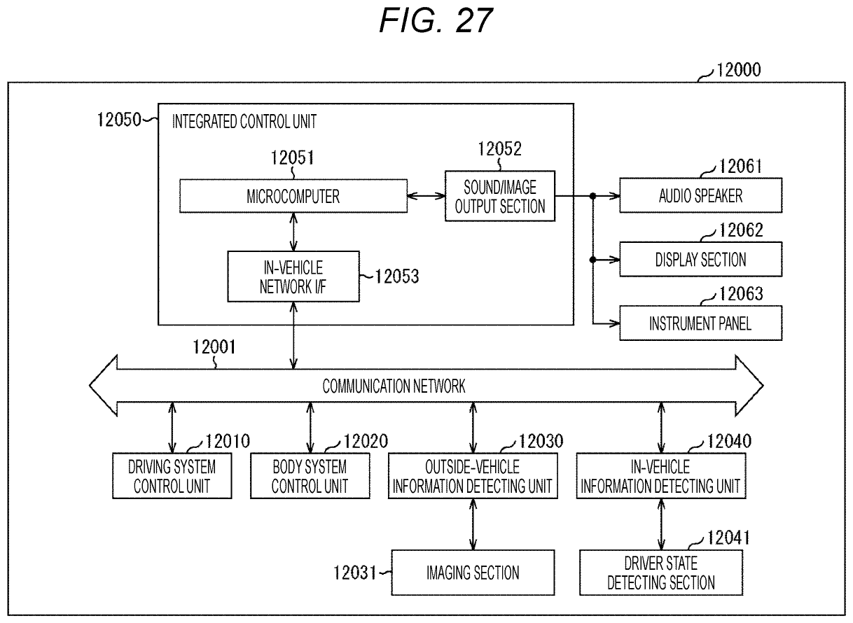

FIG. 27 is a block diagram illustrating a schematic configuration example of a vehicle control system that is an example of a mobile body control system to which the technology according to the present disclosure can be applied.

The vehicle control system 12000 includes a plurality of electronic control units connected to each other via a communication network 12001. In the example illustrated in FIG. 27, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and an in-vehicle network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of information about the outside of the vehicle acquired by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 27, an audio speaker 12061, a display section 12062, and an instrument panel 12063 are illustrated as the output device. The display section 12062 may, for example, include at least one of an on-board display and a head-up display.

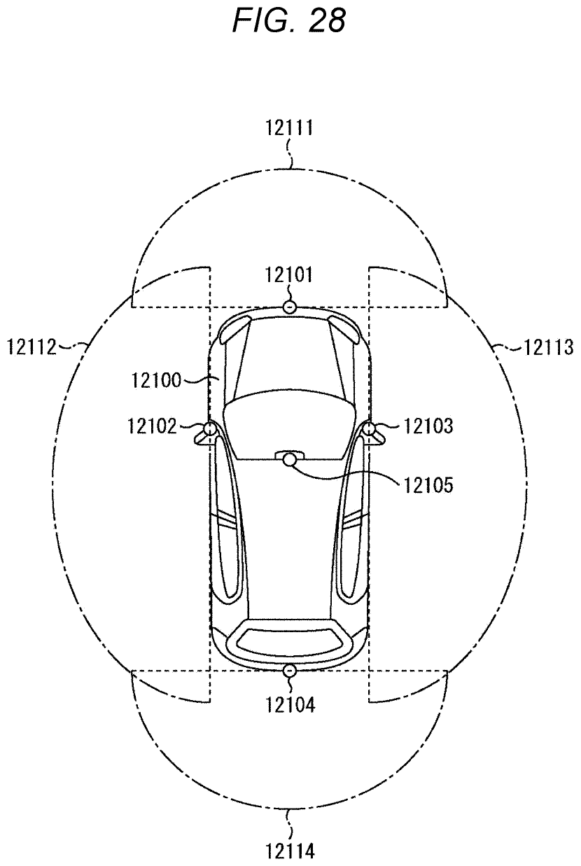

FIG. 28 is a diagram illustrating an example of installation positions of the imaging section 12031.

In FIG. 28, a vehicle 12100 includes imaging sections 12101, 12102, 12103, 12104, and 12105, as the imaging section 12031.

The imaging sections 12101, 12102, 12103, 12104, and 12105 are provided at positions, for example, a front nose, sideview mirrors, a rear bumper, a back door, an upper portion of a windshield within the interior of the vehicle, and the like of the vehicle 12100. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors mainly acquire images of the sides of the vehicle 12100. The imaging section 12104 provided to the rear bumper or the back door obtains mainly an image of the rear of the vehicle 12100. A front image acquired by the imaging sections 12101 and 12105 is mainly used to detect vehicles ahead, pedestrians, obstacles, traffic lights, traffic signs, lanes, and the like.

Note that, FIG. 28 illustrates an example of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to, for example, the imaging section 12031 among the constituents described above. Specifically, the photodetection device described above can be implemented on the imaging section 12031. The technology according to the present disclosure is applied to the imaging section 12031, whereby sensitivity characteristics are improved, so that accurate distance information can be obtained, and functionality and safety of the vehicle 12100 can be improved.

Note that the present technology can also employ the following configurations.

(1) A photodetection device including:
a plurality of pixels that counts the number of photons included in incident light;
a memory that stores a correction value used to correct a count value by each of the plurality of pixels; and
a correction circuit that corrects the count value by using the correction value, in which
the plurality of pixels includes:
an optical response unit that reacts to the photons;
a pulse detection unit that includes an input transistor to which a result of reaction of the optical response unit is input and detects a pulse indicating the result of reaction;
a counter that measures the count value on the basis of the pulse;
a dynamic separation switch unit that dynamically separates electrical connection between the optical response unit and the pulse detection unit; and
an input fixing unit that temporarily fixes an input voltage of the pulse detection unit to a potential at which the input transistor is turned on.

(2) The photodetection device according to (1), in which the potential at which the input transistor is turned on is a ground potential.

(3) The photodetection device according to (2), further including a processing circuit that calculates a dead time generated at a time of counting the number of photons on the basis of the counter value.

(4) The photodetection device according to (3), in which the correction value is a dead time calculated by the processing circuit when the input voltage is fixed to the ground potential.

(5) The photodetection device according to (4), in which the correction circuit corrects a counter value measured by the counter at a time of a state where the pulse detection unit is connected to the optical response unit, by the input fixing unit.

(6) The photodetection device according to any of (1) to (5), in which the memory is a frame memory that stores the correction values of all of the plurality of pixels.

(7) The photodetection device according to any of (1) to (6), further including
an addition circuit that adds together the pulses of a plurality of the pulse detection units respectively arranged in the plurality of pixels, in which
the counter calculates the count value on the basis of an addition value calculated by the addition circuit.

(8) The photodetection device according to any of (1) to (6), further including
an addition circuit that adds together output signals of a plurality of the optical response units respectively arranged in the plurality of pixels, in which
the pulse detection unit detects the pulse on the basis of an addition value calculated by the addition circuit.

(9) The photodetection device according to any of (1) to (8), further including
a drive circuit that outputs a drive signal for driving the plurality of pixels; and
a timing adjustment circuit that is arranged between the plurality of pixels and the drive circuit and adjusts a timing of transmitting the drive signal to the plurality of pixels.

(10) The photodetection device according to (3), in which
the plurality of pixels includes a plurality of first pixels and at least one or more second pixels,
the photodetection device further including an averaging calculation circuit that calculates an average value of the dead time, in which
the correction circuit includes: a comparison circuit that calculates an environmental correction coefficient on the basis of a result of comparison between the average value calculated when the input voltage is fixed to the ground potential and the average value calculated when the pulse detection unit and the optical response unit are connected together; and a main calculation circuit that corrects the count value by each of the first pixels by using the environmental correction coefficient.

(11) The photodetection device according to (10), in which the second pixels each are a pixel in which the input voltage is always fixed to the ground potential or a light-shielded pixel for which the incident light is shielded.

(12) The photodetection device according to (10) or (11), in which the comparison circuit calculates the environmental correction coefficient on the basis of a result of comparison between the average value for the first pixels calculated when the input voltage is fixed to the ground potential and the average value for the second pixels calculated when the pulse detection unit and the optical response unit are connected together.

(13) The photodetection device according to (3), in which
the plurality of pixels includes a plurality of first pixels and at least one or more second pixels that are smaller in number than the plurality of first pixels and for which the incident light is shielded,
the photodetection device further including an averaging calculation circuit that calculates an average value of the dead time, in which
the correction circuit includes: a main calculation circuit that corrects the count value by each of the first pixels; and a subtraction circuit that subtracts the average value for the second pixels from a calculated value by the main calculation circuit.

(14) The photodetection device according to (13), in which
the correction circuit further includes a comparison circuit that calculates an environmental correction coefficient on the basis of a result of comparison between the average value for the first pixels calculated when the input voltage is fixed to the ground potential and the average value for the second pixels calculated when the pulse detection unit and the optical response unit are connected together, and
the main calculation circuit corrects the count value by each of the first pixels by using the environmental correction coefficient.

(15) The photodetection device according to any of (10) to (14), further including
a pixel array unit in which the plurality of first pixels and a plurality of the second pixels are arranged in a matrix, in which
the plurality of first pixels is arranged in a central region of the pixel array unit, and
the plurality of second pixels is arranged side by side in a row direction and a column direction to surround an arrangement region for the plurality of first pixels.

(16) The photodetection device according to any of (10) to (14), in which the second pixels are arranged on a substrate different from that for the first pixels are arranged.

(17) The photodetection device according to any of (10) to (14), further including
a pixel array unit in which the plurality of first pixels and the second pixels are arranged in a matrix, in which
the second pixels are arranged in a distributed manner in the pixel array unit.

(18) The photodetection device according to any of (1) to (17), in which
the pulse detection unit includes a delayer that delays output of the pulse to the counter,
the photodetection device further including an adjustment circuit that adjusts a delay time of the delayer on the basis of the dead time.

(19) A distance measuring device including a plurality of photodetection devices, in which
each of the plurality of photodetection devices includes:
a plurality of pixels that counts the number of photons included in incident light;
a memory that stores a correction value used to correct a count value by each of the plurality of pixels; and
a correction circuit that corrects the count value by using the correction value, and
the plurality of pixels includes:
an optical response unit that reacts to the photons;
a pulse detection unit that includes an input transistor to which a result of reaction of the optical response unit is input and detects a pulse indicating the result of reaction;
a counter that measures the count value on the basis of the pulse;
a dynamic separation switch unit that dynamically separates electrical connection between the optical response unit and the pulse detection unit; and
an input fixing unit that temporarily fixes an input voltage of the pulse detection unit to a potential at which the input transistor is turned on.

(20) An electronic device including photodetection devices, in which
each of the plurality of photodetection devices includes:
a plurality of pixels that counts the number of photons included in incident light;
a memory that stores a correction value used to correct a count value by each of the plurality of pixels; and
a correction circuit that corrects the count value by using the correction value, and
the plurality of pixels includes:
an optical response unit that reacts to the photons;
a pulse detection unit that includes an input transistor to which a result of reaction of the optical response unit is input and detects a pulse indicating the result of reaction;
a counter that measures the count value on the basis of the pulse;
a dynamic separation switch unit that dynamically separates electrical connection between the optical response unit and the pulse detection unit; and
an input fixing unit that temporarily fixes an input voltage of the pulse detection unit to a potential at which the input transistor is turned on.

Aspects of the present disclosure are not limited to the individual embodiments described above, but include various modifications that can be conceived by those skilled in the art, and the effects of the present disclosure are not limited to the contents described above. That is, various additions, modifications, and partial deletions are possible without departing from the conceptual idea and spirit of the present disclosure derived from the matters defined in the claims and equivalents thereof.

### REFERENCE SIGNS LIST

11 Pixel
11a First pixel
11b Second pixel
12 Optical response unit
13 Pulse detection unit
14 Dynamic separation switch
15 Counter
16 Input fixing unit
17 Addition circuit
20 Drive circuit
30 Processing circuit
50 Memory
60 Correction circuit
61 Main calculation circuit
62 Comparison circuit
63 Subtraction circuit
70 Timing adjustment circuit
80 Averaging calculation circuit
90 Distance measuring device
130 Input transistor
134 Delayer
136 Adjustment circuit
200 Electronic device

1. A photodetection device comprising:
a plurality of pixels that counts a number of photons included in incident light;
a memory that stores a correction value used to correct a count value by each of the plurality of pixels; and
a correction circuit that corrects the count value by using the correction value, wherein
the plurality of pixels includes:
an optical response unit that reacts to the photons;
a pulse detection unit that includes an input transistor to which a result of reaction of the optical response unit is input and detects a pulse indicating the result of reaction;
a counter that measures the count value on a basis of the pulse;
a dynamic separation switch unit that dynamically separates electrical connection between the optical response unit and the pulse detection unit; and
an input fixing unit that temporarily fixes an input voltage of the pulse detection unit to a potential at which the input transistor is turned on.

2. The photodetection device according to claim 1, wherein the potential at which the input transistor is turned on is a ground potential.

3. The photodetection device according to claim 2, further comprising a processing circuit that calculates a dead time generated at a time of counting the number of photons on a basis of the counter value.

4. The photodetection device according to claim 3, wherein the correction value is a dead time calculated by the processing circuit when the input voltage is fixed to the ground potential.

5. The photodetection device according to claim 4, wherein the correction circuit corrects a counter value measured by the counter at a time of a state where the pulse detection unit is connected to the optical response unit, by the input fixing unit.

6. The photodetection device according to claim 1, wherein the memory is a frame memory that stores the correction values of all of the plurality of pixels.

7. The photodetection device according to claim 1, further comprising
an addition circuit that adds together the pulses of a plurality of the pulse detection units respectively arranged in the plurality of pixels, wherein
the counter calculates the count value on a basis of an addition value calculated by the addition circuit.

8. The photodetection device according to claim 1, further comprising
an addition circuit that adds together output signals of a plurality of the optical response units respectively arranged in the plurality of pixels, wherein
the pulse detection unit detects the pulse on a basis of an addition value calculated by the addition circuit.

9. The photodetection device according to claim 1, further comprising
a drive circuit that outputs a drive signal for driving the plurality of pixels; and
a timing adjustment circuit that is arranged between the plurality of pixels and the drive circuit and adjusts a timing of transmitting the drive signal to the plurality of pixels.

10. The photodetection device according to claim 3, wherein
the plurality of pixels includes a plurality of first pixels and at least one or more second pixels,
the photodetection device further comprising an averaging calculation circuit that calculates an average value of the dead time, wherein
the correction circuit includes: a comparison circuit that calculates an environmental correction coefficient on a basis of a result of comparison between the average value calculated when the input voltage is fixed to the ground potential and the average value calculated when the pulse detection unit and the optical response unit are connected together; and a main calculation circuit that corrects the count value by each of the first pixels by using the environmental correction coefficient.

11. The photodetection device according to claim 10, wherein the second pixels each are a pixel in which the input voltage is always fixed to the ground potential or a light-shielded pixel for which the incident light is shielded.

12. The photodetection device according to claim 10, wherein the comparison circuit calculates the environmental correction coefficient on a basis of a result of comparison between the average value for the first pixels calculated when the input voltage is fixed to the ground potential and the average value for the second pixels calculated when the pulse detection unit and the optical response unit are connected together.

13. The photodetection device according to claim 3, wherein
the plurality of pixels includes a plurality of first pixels and at least one or more second pixels that are smaller in number than the plurality of first pixels and for which the incident light is shielded,
the photodetection device further comprising an averaging calculation circuit that calculates an average value of the dead time, wherein
the correction circuit includes: a main calculation circuit that corrects the count value by each of the first pixels; and a subtraction circuit that subtracts the average value for the second pixels from a calculated value by the main calculation circuit.

14. The photodetection device according to claim 13, wherein
the correction circuit further includes a comparison circuit that calculates an environmental correction coefficient on a basis of a result of comparison between the average value for the first pixels calculated when the input voltage is fixed to the ground potential and the average value for the second pixels calculated when the pulse detection unit and the optical response unit are connected together, and
the main calculation circuit corrects the count value by each of the first pixels by using the environmental correction coefficient.

15. The photodetection device according to claim 10, further comprising
a pixel array unit in which the plurality of first pixels and a plurality of the second pixels are arranged in a matrix, wherein
the plurality of first pixels is arranged in a central region of the pixel array unit, and
the plurality of second pixels is arranged side by side in a row direction and a column direction to surround an arrangement region for the plurality of first pixels.

16. The photodetection device according to claim 10, wherein the second pixels are arranged on a substrate different from that for the first pixels are arranged.

17. The photodetection device according to claim 10, further comprising
a pixel array unit in which the plurality of first pixels and the second pixels are arranged in a matrix, wherein
the second pixels are arranged in a distributed manner in the pixel array unit.

18. The photodetection device according to claim 1, wherein
the pulse detection unit includes a delayer that delays output of the pulse to the counter,
the photodetection device further comprising an adjustment circuit that adjusts a delay time of the delayer on a basis of the dead time.

19. A distance measuring device comprising a plurality of photodetection devices, wherein
each of the plurality of photodetection devices includes:
a plurality of pixels that counts a number of photons included in incident light;
a memory that stores a correction value used to correct a count value by each of the plurality of pixels; and
a correction circuit that corrects the count value by using the correction value, and
the plurality of pixels includes:
an optical response unit that reacts to the photons;
a pulse detection unit that includes an input transistor to which a result of reaction of the optical response unit is input and detects a pulse indicating the result of reaction;
a counter that measures the count value on a basis of the pulse;
a dynamic separation switch unit that dynamically separates electrical connection between the optical response unit and the pulse detection unit; and
an input fixing unit that temporarily fixes an input voltage of the pulse detection unit to a potential at which the input transistor is turned on.

20. An electronic device comprising photodetection devices, wherein
each of the plurality of photodetection devices includes:
a plurality of pixels that counts a number of photons included in incident light;
a memory that stores a correction value used to correct a count value by each of the plurality of pixels; and
a correction circuit that corrects the count value by using the correction value, and
the plurality of pixels includes:
an optical response unit that reacts to the photons;
a pulse detection unit that includes an input transistor to which a result of reaction of the optical response unit is input and detects a pulse indicating the result of reaction;
a counter that measures the count value on a basis of the pulse;
a dynamic separation switch unit that dynamically separates electrical connection between the optical response unit and the pulse detection unit; and
an input fixing unit that temporarily fixes an input voltage of the pulse detection unit to a potential at which the input transistor is turned on.
